(19) United States
(12) Patent Application Publication
(10) Pub. No.: US 2026/0324569 A1
(43) Pub. Date: Oct. 22, 2026

(54) METHODS AND APPARATUS FOR AUTOMATED PLANT CARE

(71) Applicant: Flitsch Robert, North Providence, RI (US)

(72) Inventor: Flitsch Robert, North Providence, RI (US)

(21) Appl. No.: 19/529,112

(22) Filed: Feb. 4, 2026

Related U.S. Application Data
(60) Provisional application No. 63/754,772, filed on Feb. 6, 2025.

(51) Int. Cl. A01G 27/00; A01G 27/02

(52) U.S. Cl. CPC A01G 27/003; A01G 27/006; A01G 27/02

(57) ABSTRACT

A plant support system is disclosed for automated care of plants growing in a substrate. In some examples, the system may include at least one substrate sensing mechanism configured to evaluate conditions of a plant growth medium, a fluid access mechanism configured to deliver water, nutrient solutions, or combinations thereof, and a programmable control subsystem operatively coupled to the sensing and fluid delivery mechanisms. The control subsystem may be configured to regulate fluid delivery based at least in part on sensed conditions. Power may be supplied by internal or external sources to support autonomous operation. In some configurations, the system may be implemented as a modular architecture including a main system body and one or more plant-interfacing modules coupled via modular connections that convey power, data, and fluid. The system may be deployed across residential, commercial, or greenhouse environments and may support scalable, extensible, and integrated plant care applications.

### CROSS REFERENCE TO RELATED APPLICATIONS

The present application claims the benefit under 35 U.S.C. § 119(e) of U.S. Provisional Patent Application No. 63/754,772, filed Feb. 6, 2025, the contents of which are hereby incorporated by reference.

### FIELD OF THE INVENTION

The present disclosure relates to methods and apparatus that support automated care of plantings. The concept includes a plant support system that may integrate active sensing and soil monitoring directly into a body of a plant support system or a plant support system insert that may be placed into a pot. Unlike existing solutions that provide passive watering methods (e.g., wicking bulbs) or separate devices, this system configures a built-in solution. The methods and apparatus may be applied to the provision of water and/or nutrients in a controlled manner involving automated controls, smart device communication, and integration as well as optimization based on artificial intelligence algorithms.

### BACKGROUND OF THE INVENTION

Various approaches have been used to provide water and nutrients to plants, ranging from simple passive devices to electronically assisted systems. Some solutions rely on passive mechanisms, such as wicking or gravity-fed arrangements, which may be suitable for certain plant types or substrates but may not perform consistently across different conditions. Other approaches utilize timer-based irrigation systems that deliver water at predefined intervals. While these systems may simplify plant care in some contexts, they generally operate without direct consideration of real-time substrate conditions, which may limit their ability to respond to changing plant or environmental needs. Depending on the implementation, current systems may introduce concerns related to appearance, power supply, installation complexity and its associated user-unfriendliness, portability, or compatibility with existing pots and planting arrangements.

Accordingly, there is ongoing interest in plant care solutions that more closely integrate sensing, control, fluid delivery, and power in forms that may support autonomous operation, adaptability to different plantings, and flexible deployment across a range of environments and system scales. It would be desirable to have an improved apparatus and methods for its use and production that provide plantings with built-in or compact devices that include sensing and monitoring capabilities to automate the provision of water and/or nutrients in advanced and controlled manners.

### SUMMARY OF THE INVENTION

Accordingly, the present disclosure provides description for methods and apparatus for automated plant care that are easily implementable and include the capability to provide advanced monitoring and automatic operation. In some examples, an insert with storage for water and power, and structure to contain automation and communication capabilities may be employed. In other examples, the base system may be configured as a plant support system insert that contains the growth substrate and planting itself. In these examples, there may be further cases where an automated watering device may interact with the base apparatus of the present disclosure or may receive control information from wireless communication systems that allow for mobile water refilling and nutrient refill. For example, a robotic device may be part of the integrated system of automated plant care and may interface with planting insert to reprovision their storage elements with water, nutrients, and power in various examples. In some other examples, power may be collected with photovoltaic cells to charge power storage elements of the various devices.

### BRIEF DESCRIPTION OF THE DRAWINGS

The accompanying drawings, which are incorporated in and constitute a part of this specification, illustrate several examples of the invention and, together with the description, serve to explain the principles of the invention:

FIG. 1A illustrates a cross-sectional diagram of an exemplary smart watering insert component of an automated plant care apparatus.

FIG. 1B illustrates a close-up system overview of an exemplary smart watering insert component.

FIG. 1C illustrates an alternative example as a close-up system overview of an exemplary smart watering insert component.

FIGS. 1D and 1E illustrate exemplary alternatives to the location of water reservoirs.

FIG. 2A illustrates a cross section of an exemplary smart plant support system shaped insert example comprising structure to carry and support the planting and the plant growth media.

FIG. 2B illustrates a perspective view of an exemplary smart plant support system shaped insert example.

FIG. 2C illustrates a perspective view of an exemplary smart plant support system shaped insert example configured in a standard pot and interacting with a robotic device configured to reprovision the smart plant support system insert example.

FIG. 3 illustrates a schematic for componentry of a mobile provisioning system.

FIG. 4 illustrates a schematic for componentry of a mobile provisioning system configured with algorithmic and/or hardware based artificial intelligence and machine learning capabilities.

FIG. 5 illustrates componentry of exemplary controller and processing systems of the automated plant care systems.

FIG. 6 illustrates exemplary communication aspects of the various components of an automated plant care system.

FIG. 7 illustrates exemplary componentry of smart devices that may be used to interact with or be a part of an automated plant care system.

FIG. 8 illustrates exemplary methodology of automated plant care systems.

FIG. 9 illustrates further exemplary methodology of automated plant care systems.

FIG. 10A is a perspective view illustrating an exemplary main system body of an autonomous plant support system.

FIG. 10B is a perspective view illustrating an exemplary active chain unit connectable to a main system body or other chain units.

FIG. 10C is a perspective view illustrating an exemplary pass-through chain unit for extending system reach.

FIG. 10D is a detailed view illustrating an exemplary modular hookup interface.

FIG. 11A is a diagram illustrating an exemplary dual grow-bed system installation using a single main system body and additional modular features.

FIG. 11B is a diagram illustrating an exemplary system configuration including an extension pass-through chain unit.

FIG. 11C is a diagram illustrating an exemplary autonomous plant support system with remotely located installation of a main system body.

FIG. 12A is a diagram illustrating an exemplary expanded system including additional active chain units.

FIG. 12B is a diagram illustrating an exemplary system configuration providing individualized care to multiple plant groupings.

FIG. 13 is a diagram illustrating an exemplary solar-powered configuration of an autonomous plant support system.

FIG. 14A is a diagram illustrating exemplary sprinkler-based water distribution configurations for an autonomous plant support system.

FIG. 14B is a diagram illustrating exemplary drip-line water distribution configurations for an autonomous plant support system.

FIG. 14C is a diagram illustrating an exemplary system configuration including additional sensors and nutrient provisioning components.

FIG. 15 is a diagram illustrating exemplary alternative water sourcing options for an autonomous plant support system.

FIG. 16A is a sectional view illustrating an exemplary autonomous plant support system utilizing a main system body configured for placement in or on a plant pot.

FIG. 16B is an alternate sectional view illustrating exemplary internal component arrangements of an exemplary main system body.

FIG. 17A is a diagram illustrating an exemplary small pot mounting configuration of an autonomous plant support system utilizing a main system body.

FIG. 17B is a diagram illustrating an exemplary large pot mounting configuration of an autonomous plant support system utilizing a mounting and positioning case.

FIG. 17C is a diagram illustrating exemplary components that may be used in configuring and installing an autonomous plant support system for small pots.

FIG. 17D is a diagram illustrating an exemplary drip-line water distribution configuration of an autonomous plant support system.

FIG. 18A is a sectional view illustrating an exemplary autonomous plant support system utilizing a main system body with a modular hookup and pump-manifold configuration.

FIG. 18B is a diagram illustrating an exemplary system configuration utilizing modular hookup capabilities to autonomously care for multiple plants in multiple pots.

FIG. 19A is a sectional view illustrating an exemplary autonomous plant support system utilizing a main system body configured for use with an external water source.

FIG. 19B is a sectional view illustrating an exemplary autonomous plant support system with a modular hookup and pump-manifold configuration.

FIG. 19C is a diagram illustrating an exemplary system configuration using an external water source.

FIG. 20 is a sectional view illustrating an exemplary autonomous plant support system configured to provision multiple potted plants.

FIG. 21A is a diagram illustrating an exemplary autonomous plant support system with a parallel configuration of active chain units.

FIG. 21B is a diagram illustrating an exemplary autonomous plant support system with a serial configuration of active chain units.

FIG. 22A is a section view illustrating an exemplary multi-unit autonomous plant support system connected via a pass-through chain.

FIG. 22B is an alternate view illustrating an exemplary autonomous plant support system utilizing a main system body configured to care for multiple plants.

### DETAILED DESCRIPTION OF PREFERRED EXAMPLES

The present disclosure relates to methods and apparatus for automated plant care. As used herein, “automated plant care” may include control of systems to disperse water and nutrients, monitor plant substrate conditions, monitor plant growing conditions and the automation of refilling operations for the systems to disperse water and nutrients.

Some examples may include a comprehensive concept for a plant support system (sometimes called a smart plant support system, or an autonomous plant support system) that integrates active sensing and soil monitoring directly. This system may aim to address the limitations of existing solutions, such as passive devices and timer-based systems, by offering a built-in, aesthetically pleasing solution.

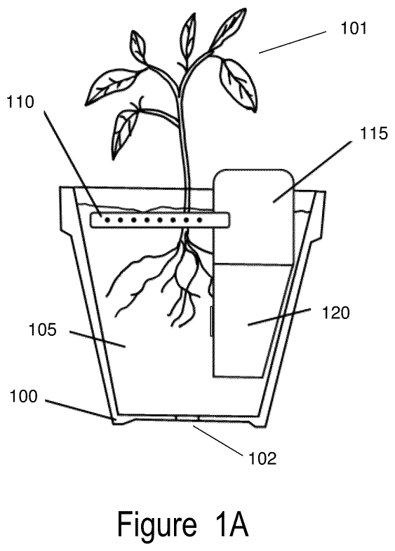

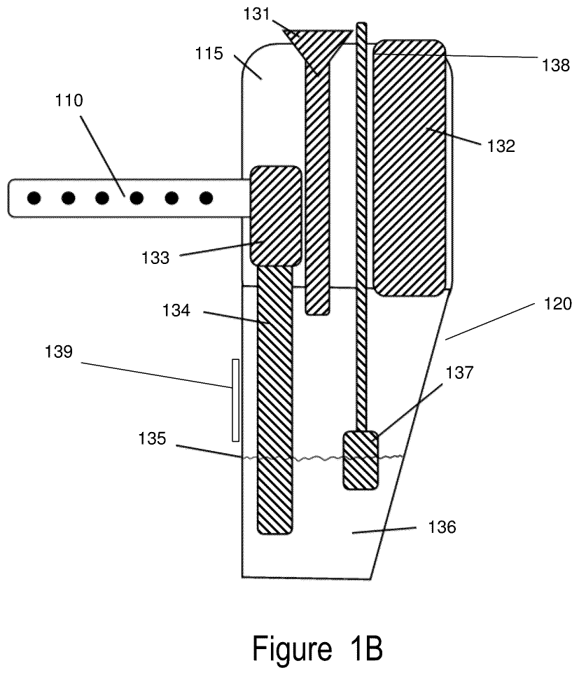

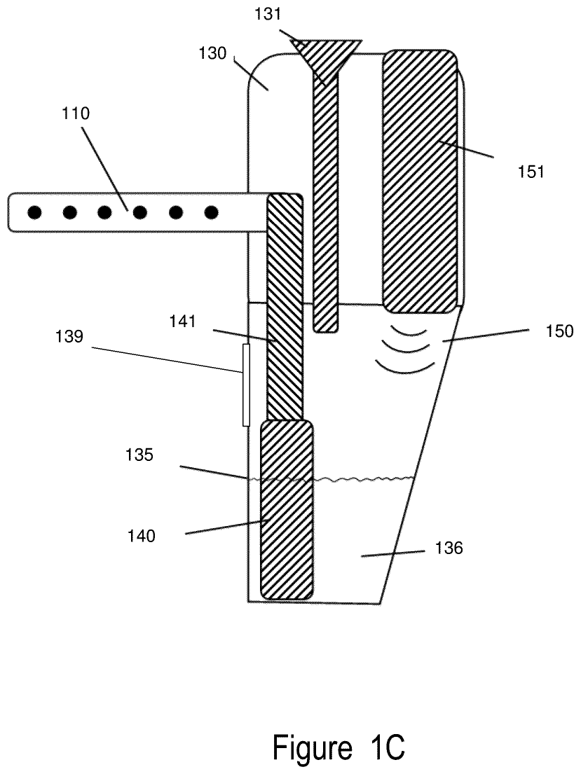

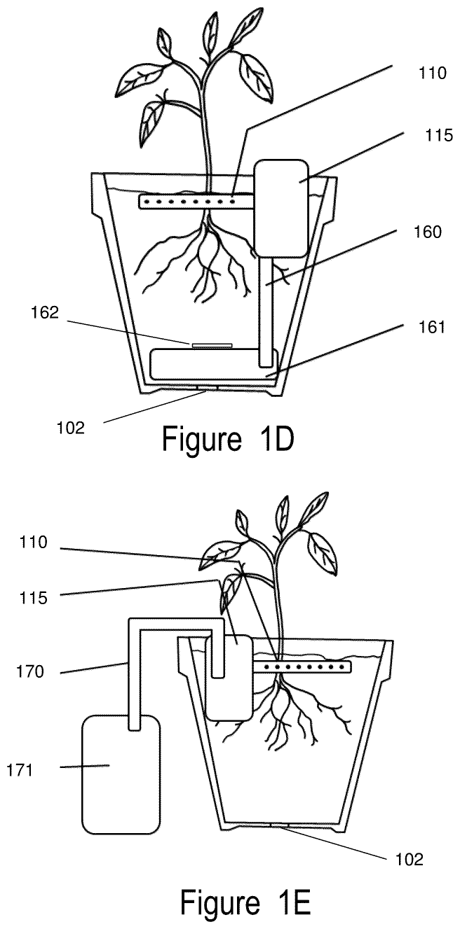

Referring now to FIG. 1A, an exemplary plant support system may involve a standard pot 100 of some design obtained by the user with a substrate medium 105 such as dirt, vermiculite, and other growth medium. The pot may include a drainage hole 102, or multiple holes in other examples. The standard pot 100 may contain a plant, multiple plants, or plantings 101. The system may include an insert 115 that may be filled into the substrate medium 105 such that its'depth may allow a water delivery element 110 such as a drip line to reside close to the surface of the substrate medium 105. This water delivery element 110 may reside above or below the surface of the substrate medium 105, depending on the exact component of water delivery (including a drip line, spray nozzle, or other possible means), the needs of the plant, or user preferences or needs (including ease of servicing the water delivery element 110). The water delivery element 110 is so-called, because it may typically disperse water to the substrate medium 105, for the health of the plant; different fluid mixtures, including but not limited to water mixed with nutrients for the plant's health (such as a nitrifying plant food mixture), may also be transported and distributed to the substrate medium 105 via the water delivery element 110. The insert 115 may include a water reservoir 120.

Referring now to FIG. 1B, exemplary details of this insert type element of a plant support system is illustrated. The insert 115 may include numerous features such as a reservoir fill port 131, a module 132 to contain user I/O, power, communication, controllers, other electronic systems, and the like. The insert 115 may include a pump 133 shown in this example as residing above the water reservoir 120. The pump 133 may draw water 136 below a water level 135 through a pump intake 134. The insert 115 may also include a water level sensor 137 (which in some examples may also include a visual indicator 138 for the user), active sensors 139, a computerized control system, and a modular design to cater to user preferences and specific needs. This integration may eliminate the need for separate, unsightly devices and provide a more efficient solution for plant care that may be flexible for alternative designs of a planting pot of a user.

As used herein, the term “sensor” may refer, in some examples, to a sensing element configured to evaluate one or more conditions of a substrate associated with a plant. In certain examples, such evaluation may include measurement of water content, water availability, matric potential, or related moisture metrics within the substrate. In other examples, additionally or alternatively, the sensing element may be configured to sense one or more other substrate characteristics, including, without limitation, nutrient concentration, nutrient availability, ion concentration, electrical conductivity, salinity, pH, oxidation-reduction potential (ORP), chemical composition, mineral composition, organic content, dissolved solids, particle size, particle size distribution, porosity, compaction, bulk density, gas permeability, oxygen availability, carbon dioxide concentration, microbial activity indicators, temperature, thermal gradients, or other physical, chemical, electrochemical, or biological properties relevant to plant growth, stress, or health.

In various examples, sensing of substrate conditions may be performed using physical contact sensors, such as probes, electrodes, pads, prongs, or similar elements that interact directly with the substrate. In other examples, sensing may be performed using non-contact or non-physical sensing modalities, including optical, electromagnetic, capacitive, inductive, resistive, acoustic, ultrasonic, radio-frequency, microwave, spectroscopic, imaging-based, or other sensing techniques, whether operating alone or in combination. In some examples, sensing may include inference-based sensing in which one or more substrate conditions are estimated indirectly from measured parameters using models, calibration data, sensor data from other nearby system components in similar substrates, sensor data from comparable substrates measured at different times/locations, historical trends, or algorithmic processing. As used herein, the term “substrate” is intended to broadly encompass plant growth media of various types and compositions, including soil, potting mixes, plant nutrient mixes, compost material and other nutrient-enriching soil additives, hydroponic media, aeroponic media, coco coir, peat-based media, mineral substrates, synthetic substrates, or combinations thereof, and is not limited to soil in any particular mineralogical, organic, or compositional definition. In some examples, such as hydroponics, where a traditional soil substrate may not be used, sensors of an autonomous plant support system may be operant within or proximate to growing vessels to sense characteristics of the fluid in a manner like that of a traditional substrate, with regards to gathering data as input for an autonomous response loop to provision care for the plantings.

In certain illustrative examples, a physical probe sensor optimized for measurement of moisture may be employed. However, the present disclosure is not limited to such configurations, and in other examples may include one or more general sensing apparatus configured to evaluate substrate characteristics according to application-specific, plant-specific, environmental, or user-specific requirements. In some examples, multiple sensing elements may be distributed spatially, vertically, or radially within the substrate to capture gradients or localized conditions. In other examples, sensed data may be combined with environmental data, plant phenotype data, historical data, or externally sourced information to inform control decisions. Accordingly, the selection, configuration, placement, number, and operation of sensing elements may vary between implementations without departing from the scope of the present disclosure. As well, the term “sensor” may refer, in some examples, to a sensing element configured to evaluate one or more conditions of a plant's environment that is separate from that of the substrate alone. This may include sensors to evaluate conditions of temperature, air humidity, ambient gas makeup and/or concentration, air particulate count/size, precipitation type or amount, wind speed, wind direction, sunlight contact, sunlight intensity, and sunlight direction, or sound sensors tuned for various frequencies including ultrasonic, as non-limiting examples.

As used herein, the term “power” refers generally to a means for supplying energy sufficient to operate the system and its components, and is not limited to a particular source, voltage, or current rating. In various examples, power may be supplied by an external power source, including wired connections delivering AC or DC power, or other externally provided electrical sources appropriate to the scale and operational requirements of the system.

In some smaller-scale or portable implementations, a battery (chargeable or single use, for example), a fuel cell, or other on-board energy storage or energy generation element may be advantageous. In some implementations, a hard-wired power connection may be desired to eliminate the need for battery replacement, to allow for recharging of batteries without removing the batteries from the device, or to supply higher power levels than would be practical using batteries alone. Although certain examples described herein utilize a battery, the invention is intended to encompass power sources of any suitable kind, whether internal or external.

As used herein, “water” may include water alone or in combination with nutrients, fertilizers, additives, dissolved solids, or other fluid constituents suitable for plant support. In some examples, fluid movement may be driven by localized fluid delivery elements such as a pump, valve, pressure differential, gravity, pressurized fluid interfaces, capillary action, or combinations thereof.

As used herein, the terms “reservoir” and “water source” may include various sources where water may be retrieved from using various means and are not limited to a single type of water source. While this may include a reservoir of standing water stored in a vessel (whether built-in to a system component, or kept remote from certain system components), this may also include as non-limiting examples a pipe or tube that water is water retrieved from (at relative pressure, or not), a fitting or spigot that water is retrieved from (at relative pressure, or not) or any combinations of exemplary water sources used to store or deliver water to the system for use.

As used herein, “programmable control element” may include one or more processors, controllers, computing modules, or distributed processing elements executing stored or received instructions.

Control logic may be executed locally, remotely, or in a distributed manner without departing from the scope of the disclosure.

As used herein, “autonomous” refers to operation without continuous user intervention and may include fixed, mobile, or partially mobile systems unless expressly stated.

As used herein, “active” refers to a sensor that is electrically energized or interrogated during operation. “Active” may also refer to components that are electrically energized, controlled to change state or perform a task during operation, or otherwise operant in an autonomous plant support system, as non-limiting examples.

Referring now to FIG. 1C, an alternative insert type with contactless means of measuring a water level. The alternative insert 130 may include numerous features such as a reservoir fill port 131, a module 151 to contain user I/O, power, communication, controllers, and other electronic systems and the like, and a contactless water level sensor 150. The insert 130 may include a pump 140 shown in this example as residing beneath the water reservoir level 135. The pump 140 may draw water 136 through a pump output channel 141. The insert 130 may also include a contactless water level sensor 150, active sensors 139, a computerized control system, and a modular design to cater to user preferences and specific needs. In some examples, the contactless water level sensor 150 may emit sound waves to assess a level of the water. In some other examples, electromagnetic radiation may be used to measure the level of the water with laser or other types of light reflection or other such electromagnetic means.

In some examples a plant support system may incorporate a water delivery system that includes a pump to draw water from the reservoir, a drip line, spray nozzle, or other water delivery means to distribute water evenly across the soil surface, and a drainage screen to prevent sediment build-up. Additionally, the system may feature overflow protection via a drainage outlet to prevent overfilling, configured to support the safety of electronics and soil. In some examples, the design aims may provide precise moisture control and prevent overwatering or underwatering, which may be common issues with existing solutions.

Referring now to FIG. 1D, an alternative of an insert where the water reservoir is moved to a location of the bottom of the system is illustrated. An insert 115 may have control elements, and pumping elements located at a different location from the water vessel 161 which may reside at the bottom of a system. For the purposes of the various examples, it may be noted that the pump placement may be at different locations within the scope of the present disclosure. For example, the pump of the pumping system may be located in the reservoir, or at locations outside the reservoir which may be in the insert device or remote from it. The water vessel 161 may have a screened opening 162. The water vessel 161 may have a shape that allows for excess water to drain out of the substrate and around the water vessel 161, out of the pot's drainage hole 102. The water may be lifted from the vessel through a pump intake 160. Water may be distributed throughout the plant substrate with a water delivery element 110.

Referring now to FIG. 1E, an alternative of an insert where the water reservoir is located remotely from the system is illustrated. An insert 115 may have control elements, and pumping elements located at a different location from the water vessel 171 outside the system. Such a reservoir may service one or more systems of this type. The water from the water vessel 171 may pass to the pump from the pump intake 170 and be pumped to a water delivery element 110. In such cases a water delivery element may also be a drip hose, spray nozzle, or other means of distributing water or other fluids.

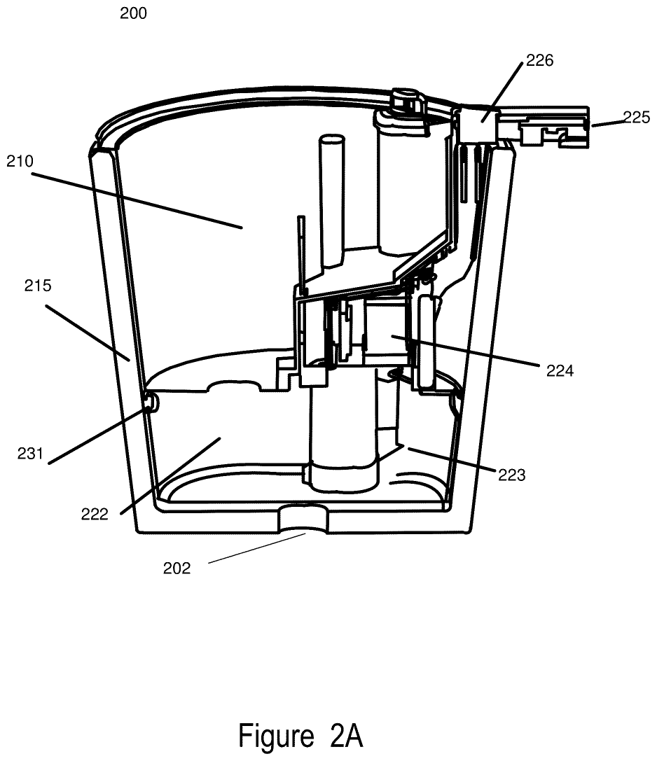

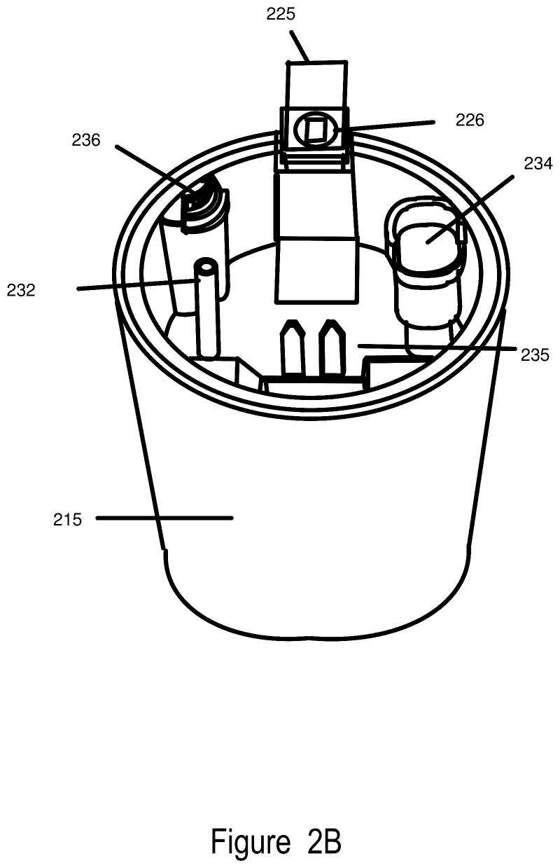

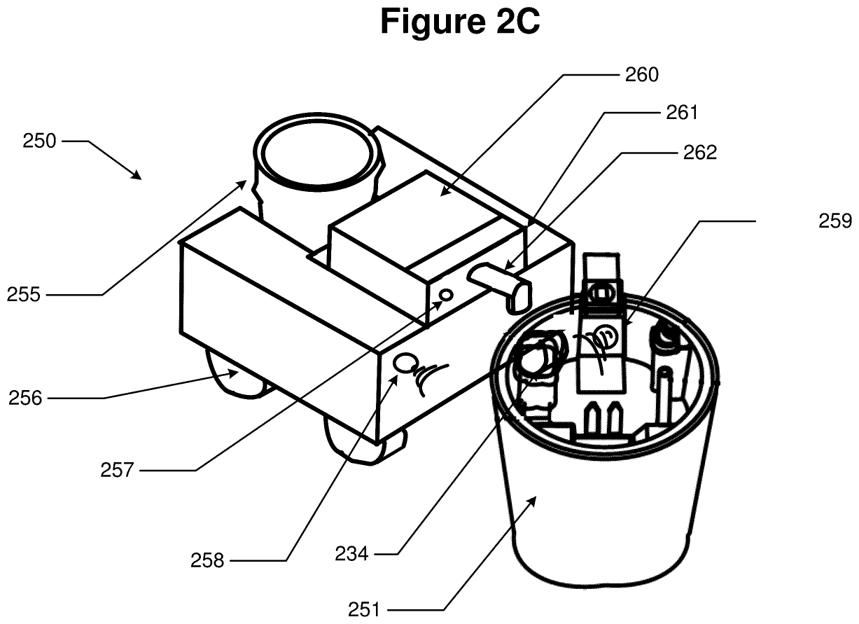

Another type of smart plant support system or plant support system may revolve around a design where components for storing, controlling, sensing, and distributing water to a planting in a vessel may be contained in a plant support system insert shaped to fit inside a decorative pot of standard designs. Referring to FIG. 2A, item 200, a cross section of a plant support system insert 210 in a decorative pot 215 is illustrated. For different decorative pot sizes and shapes a different implant base may be modelled and formed. Internal components of the system may be attached and formed into the base. For example, a water tank 222 may be fastened, welded, or formed to the base of the insert plant support system 210. The water tank being located lower than the plant and plant growth media may allow for water to percolate through the growth media and return to the water tank 222 in some examples. In other examples, excess water may be allowed to flow past the water tank 222, to drain out the bottom drainage hole 202 of the decorative pot 215. A pump 223 may be included to pump water from the water tank 222. A control box 224 may be included at a point above a water storage amount. In some examples, a charging port 225 may be included to allow for batteries in the control box 224 to be charged and powered. In other examples, a battery may be removable to be charged separately from the insert plant support system 210. The system may have control interfaces. In a simple example a switch 226 may be used for interface. In some examples, an insert may include a penetration, hole, or drain at a top 231. Should over-filling occur the water may drain out of the water tank 222 and not damage the control box or pumping unit.

Referring now to FIG. 2B, a perspective of the plant support system insert illustrated in cross section in FIG. 2A. is found. In addition to the decorative pot 215, the charging port 225 and the switch 226 there may be a physical fill indicator 232, a fill funnel 234, a sensor 235 and a spray nozzle 236 may be visible in the perspective view. Other means of water dispersal or delivery may be employed as well.

A non-limiting feature of the plant support system is its modular design, which maximizes flexibility and ease of use. The system may comprise a planter module with built-in sensors, a circuit box housing the programmable control element, battery, and other control circuitry, and a water basin serving as the reservoir. This modularity may allow for different configurations, such as a complete self-contained plant support system, a plant support system insert for retrofitting existing planters, and modular connections for multiple planters sharing a single water source. This approach may offer a cost-effective solution and may enhance the system's adaptability to various applications.

The plant support system may integrate advanced sensing and diagnostics through its substrate sensors. These sensors may monitor soil conditions by measuring, through various methods, the water content or water potential of the soil (respectively, the amount of water in the soil, or the availability of water to be taken up by plants in the soil). Some methods may include measuring capacitance between sensor electrodes, or measuring resistance between sensor electrodes, as non-limiting examples. Choices among methods include tradeoffs of cost, accuracy, and lifespan of the chosen sensors, so different versions of the plant support system may employ different sensing strategies. Different formfactors for sensor electrodes (probes or pads, as non-limiting examples) may be utilized to sense for moisture at different locations around the plant. Different arrangements of a plurality of sensors (employing more than just 1 pair of sensors, for instance) may be utilized to measure soil conditions in multiple depths or locations around the plant. Other types of sensors may additionally be used to include sensing for substrate nutrient content, substrate ion content, or sensing of other contents in the substrate mixture used. A mixture of various form factors, placement, and types of sensors may enable deeper sensing of soil conditions for comprehensive monitoring. To minimize corrosion, sensor activity may be limited. This advanced sensing capability may allow the system to provide precise moisture and nutrient control to optimize plant health.

In some examples, designs may incorporate AI and IoT models, the plant support system may analyze changes in substrate conditions over time to determine plant growth stages and adjust watering schedules based on plant species, growth cycles, and environmental factors. The system may also provide diagnostics for plant health using additional sensors or cameras and may offer reminders for fertilizer addition based on plant needs. This integration of AI and IoT may enhance the system's functionality and user experience.

User interaction and control may be facilitated through wireless integration, allowing the system to connect to a mobile app via Wi-Fi or Bluetooth. Users may view historical data on watering, substrate moisture levels, other metrics of soil condition, and fertilization schedules, input notes and photos for plant identification and monitoring, view error codes or messages, check component status, calibrate components or system settings, trigger manual watering with specific system components, adjust watering schedules or thresholds, or override automatic settings as desired, as non-limiting examples. In some examples, connectivity may provide users with greater control and flexibility in managing their plant care. Examples herein referring to a “mobile app” are intended to embrace all forms of digital user interface strategies, including as non-limiting examples a website; a program hosted on one or more of a local computer, a server, and a server network; or other type of digital application allowing user interaction with the system and/or system data.

In some examples, a plant support system may include an intuitive water level monitoring features, with initial prototypes using a bobber system and future versions adopting electronic water level sensors for a more seamless design. This feature may support users to easily monitor the water level in the reservoir and maintain optimal plant health.

The system may be designed for both residential and commercial applications. In residential use, it may assist users in maintaining optimal plant health by having configurations to reduce likelihood of overwatering or underwatering, automating watering schedules, and offering precise moisture control for different plant species and conditions. In larger-scale applications, such as greenhouses, the system may use modular planters that connect to a central water source and control unit, automatically watering plants based on real-time soil readings and reducing labor needs. Modular planters that connect to a central water source, but with individually controlled units, may alternatively be desirable for a wide variety of application scales, such as office or storefront locations with a number of plants on display, or larger residential settings with large numbers of plants in a sunroom, as non-limiting examples.

For advanced scenarios, the plant support system may integrate with autonomous devices like robots that refill water reservoirs and monitor and service multiple planters with shared water sources. This integration enhances the system's efficiency and reduces the need for manual intervention, making it suitable for various applications.

Referring now to FIG. 2C, an exemplary illustration of a plant support system 251 receiving water replenishment from an autonomous device 250 is provided. There may be numerous types of autonomous devices that may refill the plant support system. The autonomous vehicle 250 may have its onboard supply 255 of water that it may coordinate refilling by interaction with a base station of the autonomous device 250. In the example of FIG. 2C the autonomous device 250 may include various types of wheel designs 256 for inside and outside operations, which may include pivoting wheels for steering, or omni-directional type wheels (omni-wheels or Mecanum wheels, as non-limiting examples) or other means to allow for precise steering and locomotion of the autonomous vehicle. In some examples, the autonomous vehicle may include camera systems 257 or other imaging systems that may determine the appropriate alignment direction of the vehicle to allow for correct alignment of a water delivery port 262 to the fill funnel 234. Both the autonomous vehicle 250 and the plant support system 251 may have communication means to interact with each other (an autonomous vehicle communication system 258 and plant support system communication system 259) which may include various wireless systems and standards such as Bluetooth, near-field, RF communications systems such as Wi-Fi and the like. Controllers 260 in the autonomous vehicles may communicate with the plant support system for status and location information and also communicate with other systems such as server-based systems for control information. In some examples, a user may utilize a smart device with an app for communicating and setting parameters of the refill process, much as smart devices with apps may communicate with the plant support system 251.

In some examples, the autonomous vehicle 250 may include mechanical controls 261 which may make fine movements to locate the water deliver port 262 to an appropriate location in relation to the fill funnel 234.

In some examples, a plant support system may include using durable materials for sensors to reduce corrosion, developing multi-plant systems with shared pumps or valves, incorporating advanced AI for plant health diagnostics, and integrating fertilizer alerts. These aspects may improve the system's functionality and user experience.

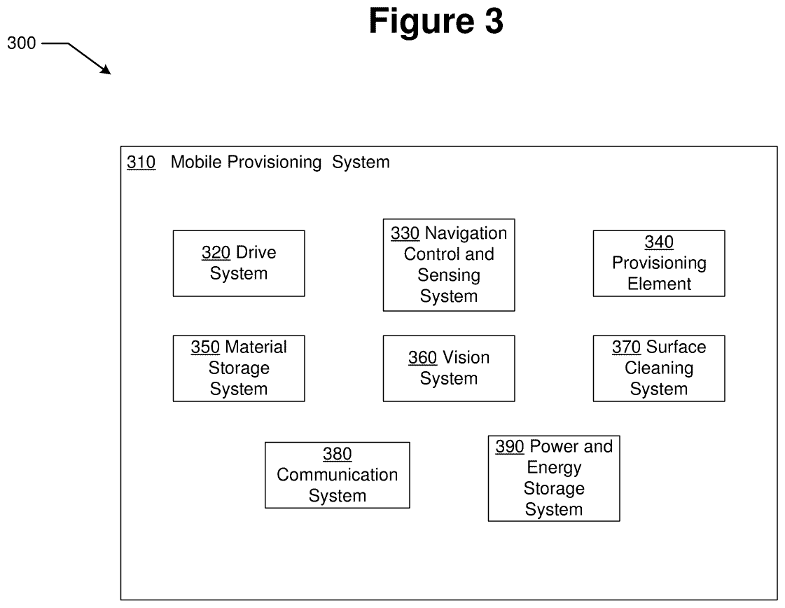

Referring to FIGS. 3, 300, some elements of an exemplary mobile provisioning system (310) may be found. The system may have a drive system 320 enabling transportation of the provisioning system over a surface. The drive system 320 may function to move the apparatus on both flat and shaped or curved topography. The drive system 320 may function on wheels, balls, tracks, or other means of conveyance known in the art. In some examples, the use of automotive or truck frames either with trailers or with modification directly to the frame itself may be used. The drive system 320 may incorporate a drive mechanism comprising an engine or motor that may act upon the conveyance elements such as wheels or may utilize transmissions and axles to drive the conveyance elements. Various forms of directional or steering control may be possible. In some examples, the differential control of multiple motors acting upon conveyance elements may allow for directional control. In other examples, the directional control may function by a steering system that moves the conveyance elements in ways other than in its drive sense. In some examples the design of the wheels and the drive systems for the wheels may define omnidirectional drive systems. In some examples three or four engineered wheels may be used to move the system in all linear directions and rotary directions without an independent steering system.

Referring again to FIG. 300, the mobile provisioning system 310 may include a Navigation, Control and Sensing system 330 that may function to determine a current location to a desired degree of accuracy as well as an orientation of the device at that location. Such information may be useful in regulating direction control through the navigation system and in determining other control variables such as speed. The sensing system may provide other environmental information to the control system such as temperature and humidity at the location and in some examples at a surface beneath the location of the system. In addition, the sensor and navigation elements may also function to provide awareness of obstacles in the environment of the mobile provisioning apparatus. A separate vision, measurement and inspection system may be present in some examples (a following discussion discusses this in detail) and may interface with the control elements or sensing elements. The control elements may receive data in various forms and may process the data utilizing computational hardware and programing algorithms.

The navigation element may utilize various protocols to generate location awareness. For example, the element may utilize GPS technology. In other examples, a local transceiver network may provide telemetry local relative location awareness through the use of RF systems, or light-based systems such as a laser-based system. This local system may function within an outdoor region or alternatively be set up to function within a building. Cell phone-based telemetry, and other schemes such as sonic location detection may provide information for telemetry. In some examples, the navigation element may provide a first order telemetry to an accuracy required to control movement of the apparatus, for example. The vision system (to be discussed) or other sensing elements may provide a next higher accuracy for calibration of location. Location marks may be present upon or within the surface and a sensor such as a camera system, for example, may pick up the location marks to calibrate the navigation system and the control system. Various other reference elements such as physically defined lines, such as found on roads or parking lots may be a type of navigation control system. Still further examples may involve the embedding of conductive wires to create a navigation information system. A grid of such conductive wires may create a calibrated work floor with a good deal of accuracy. In still further examples, the surface to be acted on by the mobile provisioning apparatus may be a temporary surface that may itself be moved. Sheets of a temporary material may function as the surface and these sheets as well may include coloration and/or physical elements such as embedded conductors to provide a telemetry signal for the navigation element.

The Navigation, Control and Sensing system 330 may include aspects of artificial intelligence such as algorithms to process and use sensing data by machine based learning and other artificial intelligence protocols. Hardware including processing units may be customized in design for artificial intelligence-based processing. The vision system in particular may be directly coupled with customized artificial intelligence-based processing equipment including artificial intelligence algorithms.

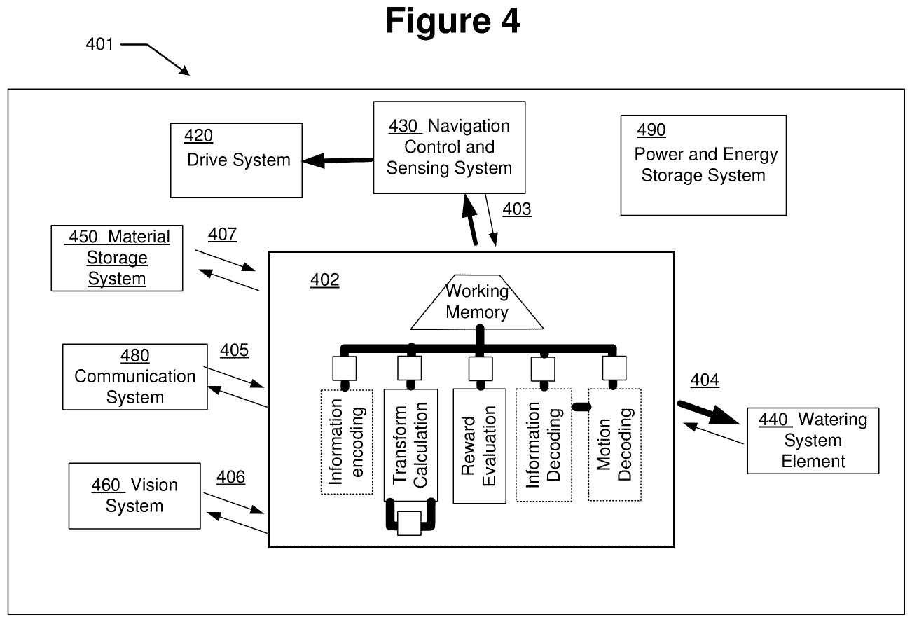

Referring to FIG. 4, an exemplary structure of an artificial based processing system or algorithm which may be implemented in both software and hardware is illustrated.

In some examples, the artificial intelligence processing system 401 may be incorporated within the navigation, control, and sensing system 430 or as illustrated it may work in concert with the navigation, control, and sensing system 430 routing data along a bus between the controllers in the navigation, control, and sensing system 430 and the artificial intelligence processing system 102. In such an example the data flows within the mobile provisioning system 403-407 may be routed through the artificial intelligence processing system 402 as illustrated or there may be parallel systems which route the data in parallel to the standard navigation, control, and sensing system 430 as well as the artificial intelligence processing system 402. The nature of data flow and signal feedback between an artificial intelligence processing system 402 create new examples of the mobile provisioning system architecture with new aspects of drive system 420, navigation, control, and sensing system 430, watering system 440, material storage system 450, vision system 460, communication system 480, and power system 490. Each of these systems may perform differently in concert with an artificial intelligence processing system 402.

For example, a vision system 460 tied to an artificial intelligence processing system 402 may use various machine learning and artificial intelligence algorithms, hardware structures, and the like to improve effectiveness in various aspects of vision system performance. Trained artificial intelligence processing systems may recognize defects, structures, and other aspects of supported plantings. The system may have as an equivalent to “motion decoding” specific interlocking of both an altered navigation, control, and sensing system 430 which may control the drive system 420 as well as simultaneous interlocking with watering system element 440. The system may also interlock with aspects of the vision system 460 where the vision system inspects the result of the plant support process and provides learning feedback which may trigger aspects of reward evaluation in the artificial intelligence system and foster improved “learning” of the system in the field and “on the fly”.

Referring now again to FIG. 4, watering system element 440 may be represented. The various equipment and techniques known in the art may be included such as valves, pumps, nozzles, drip lines, and the like.

Referring again to FIG. 3, a material storage system 350 may be found. As has been described there may be numerous types and forms of material that may be processed by a provisioning system. In some examples, water may be solely provided. In some other examples, water and fertilizer and growth substrate may be provisioned as non-limiting examples.

In the various materials examples that may be possible with a mobile provisioning system, the environmental storage conditions on the autonomous vehicle may be important. Accordingly, the material storage system 350 may have control over numerous environmental conditions such as the temperature of the material storage, the pressure, the ambient gases or a vacuum condition and the humidity to mention some examples. Thus, the material storage system for a mobile provisioning system would have control systems for the important environmental conditions. The storage system would need to allow for the automated or non-automated replenishment or replacement of the material that is located in a mobile provisioning system. In some examples various combinations of multiple material storage systems may be present. For example, a powder storage system such as may be used for fertilizers that are not already dissolved in water. In still further alternative, two different forms of material may be combined with different storage systems that feed a single dispersing element that is designed to simultaneously process the two material types.

An inspection system or a vision system 360 may perform inspections of plantings and substrate conditions.

Another element, a communication system 380 of the mobile provisioning system may be found referring to FIG. 3. In general, mobile provisioning systems may be used in combinations to perform functions. To effectively perform their function, it may be important that the mobile provisioning systems may be able to communicate with each other. The communication system may also be useful for communication between the mobile provisioning system and a fixed communication system. The fixed communication system may be useful for communicating various data to the mobile provisioning system as well as receiving data transmissions from the mobile provisioning system. The data transferred to the mobile provisioning system may include programming software or environmental target files or the data may include environmental data such as mapping data or topological data as examples. The communication may be carried by RF transmission protocols of various kinds including cellular protocols, Bluetooth protocols, and other RF communication protocols. The communication may also utilize other means of data transfer including transmissions of other electromagnetic frequencies such as infrared and optical transmissions. Sound waves may be useful for both communication and spatial mapping of the environment of the mobile provisioning system. In some examples the mobile provisioning system may be tethered to at least a communication wire that may be useful for data transmission.

Another form of communication may relate to visual based information conveyed by the mobile provisioning system body itself. In some examples, the mobile provisioning system body may include a display screen to communicate information to the surroundings in the form of graphic or visual data. As an example, the display may warn people in the environment of the mobile provisioning system as to the function that the mobile provisioning system is performing and when and to where it may move. Audio signaling may comprise part of the communication system in addition. Also, the mobile provisioning system may be configured with a light system that may project visual signals such as laser patterns, for example.

The communication system may be useful to allow external operators to provide directions to the mobile provisioning system. The directions may include the control of navigation in both a real time and a projective sense. Users may utilize the communication system to provide activation and deactivation signals. Numerous other functional control aspects may be communicated to control operation of the mobile provisioning system other than just the transfer of software programs including for example activation and control of the various subsystems.

A Power and Energy storage element 390 may be found within the mobile provisioning system. In some examples, the mobile provisioning system will operate in a wireless configuration and therefore will contain its own power system in the mobile platform. Standard combustion engines and hydrocarbon fuels may comprise a power system along with a generator driven by the engine to charge batteries as an electric charging system. In other examples, a battery powered system may power both the drive system with electric motors as well as the electronics and other systems. The battery storage system may be recharged during periods of non-use, and the components of such a recharging system may comprise portions of the power and energy storage element. In some examples where the mobile provisioning system operates in an automated fashion, the recharging of the energy storage element may also occur in an autonomous fashion whether it is recharging electrically or obtaining additional fuel stores.

There may be numerous ways to configure the novel mobile provisioning system that has been described.

### Control Systems

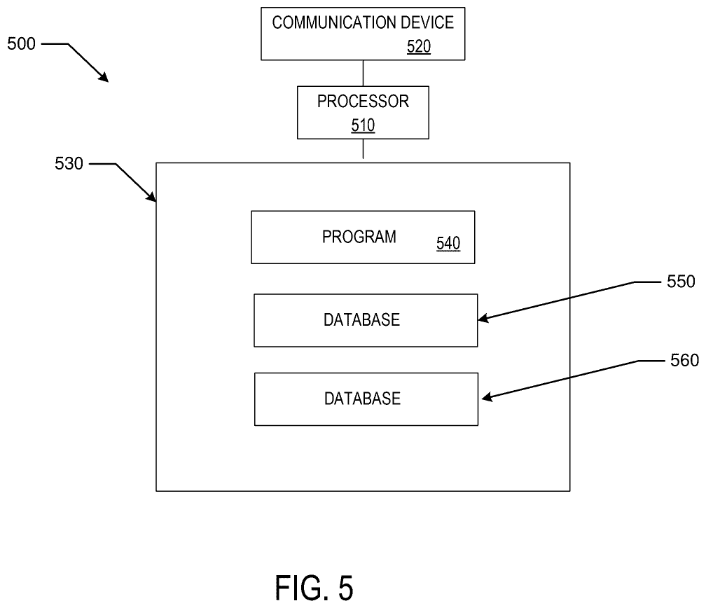

Referring now to FIG. 5, a controller 500 is illustrated that may be used in some examples of a mobile provisioning apparatus. The controller 500 includes a processor 510, which may include one or more processor components. The processor may be coupled to a communication device 520.

The processor 510 may also be in communication with a storage device 530. The storage device 530 may comprise a number of appropriate information storage device types, including combinations of magnetic storage devices including hard disk drives, optical storage devices, and/or semiconductor memory devices such as Flash memory devices, Random Access Memory (RAM) devices and Read Only Memory (ROM) devices.

At 530, the storage device 530 may store a program 540 which may be useful for controlling the processor 510. The processor 510 performs instructions of the program 540 which may affect numerous algorithmic processes and thereby operates in accordance with mobile provisioning equipment. The storage device 530 may also store mobile provisioning system related data in one or more databases 550, 560. The databases 550,560 may include specific control logic for controlling the provisioning of material.

As mentioned in reference to FIG. 4, a mobile provisioning system and also plant support system may benefit from operational incorporation of artificial Intelligence, machine learning, and other such operational control aspects. In some examples, the hardware as depicted in FIGS. 1A-1D, 1C,2 3 and 4 may include hardware and software aspects that support artificial intelligence including as non-limiting examples processors specifically designed to optimize performance of artificial intelligence algorithms, data bus designs to optimize performance between various blocks such as the vision system and controller and associated algorithms.

While the disclosure has been described in conjunction with specific examples, it is evident that many alternatives, modifications, and variations will be apparent to those skilled in the art in light of the foregoing description. Accordingly, this description is intended to embrace all such alternatives, modifications, and variations as fall within its spirit and scope.

### Communication Aspects

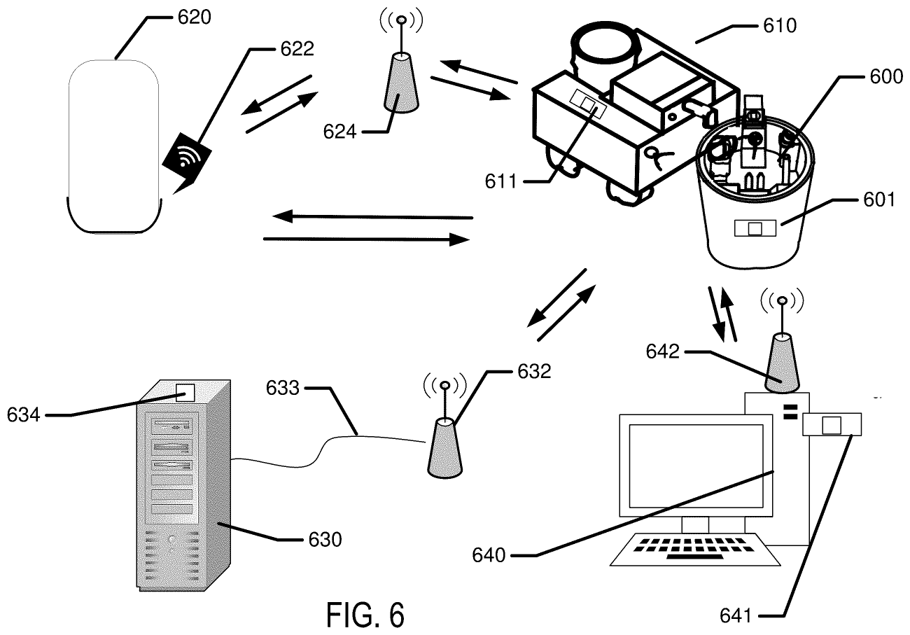

Referring now to FIG. 6, various communication paths may be illustrated. In some examples, smart devices 620 may include wireless communication capabilities 622 as have been mentioned to interact with networks 624, or with autonomous vehicles 610 through communications equipment 611 directly or with plant support system s 600 directly with communication equipment 601. In some examples, networks 624, 632 and 642 may interact with servers 630 including communication systems 634 or with user systems 640 such as desktop, laptop, notepads, or the like which have communications capabilities 641. Communications of the various systems with networks may include wired solutions 633 in some examples.

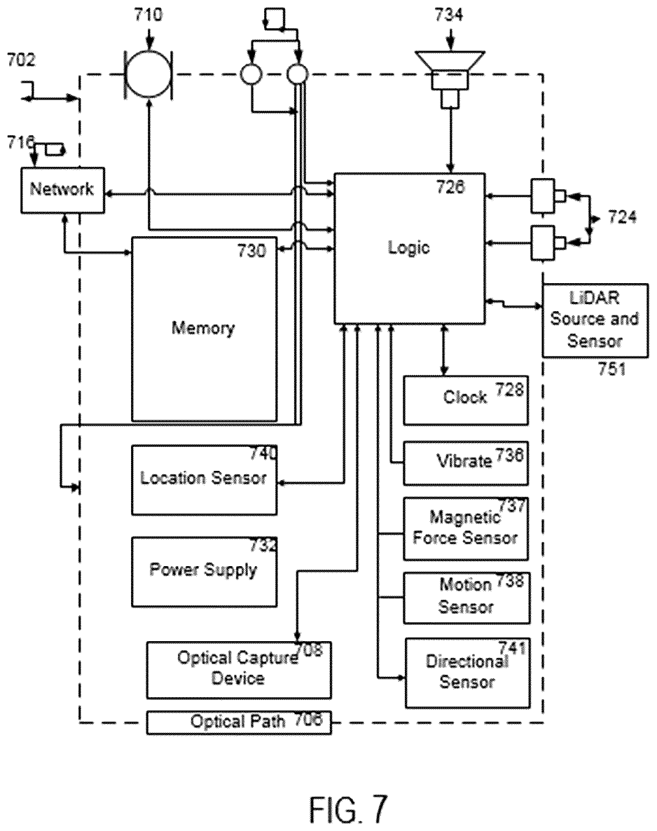

Referring now to FIG. 7, smart devices may operate as part of the communications aspects and this figure represents aspects of a smart device that may communicate data amongst the communication pathways. A smart device may have an optical capture device 708 to capture an image and convert it to machine-compatible data, and an optical path 706, typically a lens, an aperture, or an image conduit to convey the image from the rendered document to the optical capture device 708. The optical capture device 708 may incorporate a Charge-Coupled Device (CCD), a Complementary Metal Oxide Semiconductor (CMOS) imaging device, or an optical Sensor 724 of another type. The optical sensors may be utilized to inspect the status of a plant in a plant support system and of the surroundings and the growth media in some examples. A microphone 710 and associated circuitry may convert the sound of the environment, including spoken words, into machine-compatible signals. Input facilities may exist in the form of buttons, scroll wheels, or other tactile Sensors such as touchpads. In some embodiments, input facilities may include a touchscreen display. Visual feedback to the user may be possible through a visual display, touchscreen display, or indicator lights. Audible feedback 734 may come from a loudspeaker or other audio transducer. Tactile feedback may come from a vibrate module 736. A motion Sensor 738 and associated circuitry may convert the motion of the smart device 702 into machine-compatible signals. The motion Sensor 738 may comprise an accelerometer that may be used to sense measurable physical acceleration, orientation, vibration, and other movements. In some embodiments, motion Sensor 738 may include a gyroscope or other device to sense different motions. In some examples, a smart device may be located upon a mobile provisioning device. A location Sensor 740 and associated circuitry may be used to determine the location of the device. The location Sensor 740 may detect Global Position System (GPS) radio signals from satellites or may also use assisted GPS where the mobile device may use a cellular network to decrease the time necessary to determine location. The smart device 702 may include logic 726 to interact with the various other components, possibly processing the received signals into different formats and/or interpretations. Logic 726 may be operable to read and write data and program instructions stored in associated storage or memory 730 such as RAM, ROM, flash, or other suitable memory. It may read a time signal from the clock unit 728. In some embodiments, the smart device 702 may have an on-board power supply 732. In other embodiments, the smart device 702 may be powered from a tethered connection to another device, such as a Universal Serial Bus (USB) connection. The smart device 702 may also include a network interface 716 to communicate data to a network and/or an associated computing device. Network interface 716 may provide two-way data communication. For example, network interface 716 may operate according to the internet protocol. As another example, network interface 716 may be a local area network (LAN) component allowing a data communication connection to a compatible LAN. As another example, network interface 716 may be a cellular antenna and associated circuitry which may allow the mobile device to communicate over standard wireless data communication networks. In some implementations, network interface 716 may include a Universal Serial Bus (USB) to supply power or transmit data. In some embodiments other wireless links may also be implemented. A directional sensor 741 may also be incorporated into the smart device 702. The directional device may be a compass and be based upon a magnetic reading or based upon network settings. In some examples, the smart device 702 may include a LiDAR sensing system 751. The LiDAR system may include a scannable laser light (or other collimated) light source which may operate at nonvisible wavelengths such as in the infrared. An associated sensor device, sensitive to the light of emission may be included in the system to record time and strength of returned signal that is reflected off of surfaces in the environment of the smart device 702. In some examples, the structure of a planting may be ascertained by the capture of LiDAR data from one or more locations around the planting and smart/plant support system.

### Methods

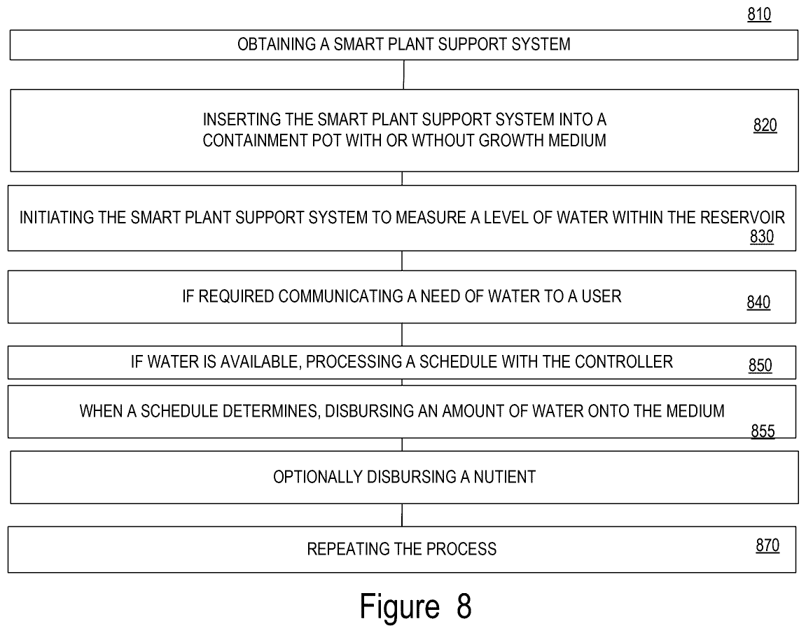

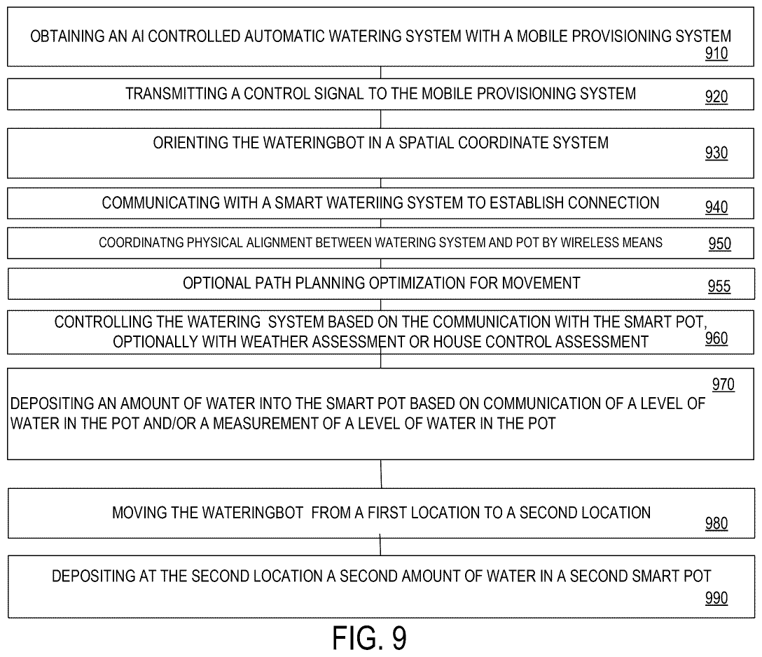

There may be numerous methods of utilizing a plant support system or manufacturing a plant support system. There may also be numerous methods of utilizing a mobile provisioning system, manufacturing a mobile provisioning system, or supporting a plant support system with a mobile provisioning system. Referring to FIG. 8, an exemplary set of method steps that may be commonly utilized in numerous examples of smart plant support systems are displayed. The steps are displayed in a flow chart for example. The steps may be flexibly used or not used, and the order of the steps may be changed within the scope of the inventive art of self-watering plant support system.

At step 810, a user may obtain a smart plant support system device of a particular type. Next, at step 820 the user may insert the smart plant support system device into a vessel with or without growth medium. At step 830, the user may initiate the smart plant support system to measure a level of water within the plant support system. In some examples, at step 840 a decision may be formed based on a requirement for additional water in the supply and a communication of the need may be made to a user. At step 850, based upon the availability of water within the smart plant support system, the controller may process a schedule of watering. At step 855, when a time referenced in a schedule is reached, a disbursement of water upon the growth medium may be performed. At step 860, in a non-limiting and optional sense a nutrient may be disbursed. At step 870, the processing may be repeated, such as beginning around step 830. The transmitting may involve numerous means including a wireless transmission, a wired transmission or a transmission involving a physical interaction such as pushing a switch or a display panel of a mobile provisioning system. The initiation signal may cause a variety of responses that are proximately caused by the initiation even if further interaction with the user is or is not required or if the mobile provisioning system will flexibly respond to its environment or programming thereafter.

### Artificial Intelligence and Machine Learning in Plant Support and Mobile Provisioning

A mobile provisioning system may be configured to utilize various degrees of data processing equipment during the course of its operations, and various aspects of its operations may be therefore automated. These automation aspects may define one of the types of operations whose automation effectiveness may be improved by the incorporation of machine learning or more generally artificial intelligence (which may also be classified as cognitive computing.) As shall be described in following sections there are also general aspects of mobile provisioning system type operations that may be configured to utilize artificial intelligence aspects.

In a general way of looking at artificial intelligence, a software program, which may in some examples be enhanced with customized computing and sensing hardware, is configured to performs tasks such as image or pattern recognition, evaluate performance of the task and adjust the operational aspects to improve performance. There may be numerous manners and algorithms that may be used to perform machine learning or cognitive computing. An example of artificial intelligence processing with particular reference to image processing may be found in the U.S. Pat. No. 9,904,889 entitled METHODS AND SYSTEMS FOR ARTIFICIAL COGNITION the contents of which were previously included by reference. These algorithms, processes and processing flows may be applied to the various uses of machine learning as described herein. It may also be noted that variations on these techniques and processes may naturally be adopted, and in some examples, different types of artificial intelligence algorithms may be applied to the operations as described.

The algorithms of the artificial intelligence may utilize in non-limiting examples, k-means clustering, adaptive resonance, reinforcement learning, Q-learning, or neural network-based models for this and all artificial intelligence algorithmic learning approaches discussed within the present specification. In some cases, the environment such as temperature, degree of sunlight or moonlight and such variables may create variation in the imagery obtained by the system, here too the artificial intelligence system may learn to interpret the imagery and adjust processing conditions as appropriate.

In some examples, an artificial intelligence system may learn to recognize different types of issues with plantings ranging from overall defect categories; such as blight, fading, burning and the like. The artificial intelligence system may determine, for example, that a particular planting may require a customized processing such as a fertilizer for example.

In some examples, an artificial intelligence system may be used to calculate paths taken by a mobile provisioning system. Different speeds and direction may be used for efficiency and effectiveness of a repair or construction action. As has been discussed herein, Mecanum wheels and other multidirectional wheel types may allow for increased flexibility. The increased flexibility may create a more complex modelling environment. An artificial intelligence system may be particularly effective in recognizing patterns of movements of the mobile provisioning system in reference to a particular task and its associated path of movement to accomplish the task. In some examples, the path may include information provided by scanning of the work area with aerial views such as those provided from a drone-based survey.

### General Aspects

Accordingly, in some examples disclosed in this disclosure, a mobile provisioning apparatus, which may be called a mobile provisioning system, may be configured to comprise a drive system which may be operative to move the apparatus along a surface. In some examples the mobile provisioning system may function with no physical tether. Advanced drive systems may incorporate omnidirectional drive capabilities without or in addition to steering components. In steered systems the direct drive components may move in a general forward and reverse direction. An omnidirectional drive component may directly impart other movements such as translational movements, to forward and back, turned movements around the center of motion, and turns during a general translational movement. An example of an omnidirectional drive component may be Mecanum wheels driven by independently controllable motors.

In addition, the mobile provisioning system may comprise a navigation system which among other functions may determine the mobile provisioning system's current location and its current bearing or direction that it would travel in when caused to move or travelling in if moving.

The mobile provisioning system may additionally comprise a controller capable of executing code which may perform an algorithmic function. In some examples such a controller may also be classified as an algorithmic processor. The controller may also provide controlling signals to other elements of the mobile provisioning system. The controller may include hardware and encoded programs tailored to perform cognitive functions, machine learning, or artificial intelligence. In some examples, the controller may interact with communication systems to link to external “control nodes” that may with communication function as part of the overall controller function.

The origin of the digital model may be determined externally to the mobile provisioning system or alternatively may be determined by sensing or other processing of the mobile provisioning system or may be a combination of external model definition combined with the data related to sensing apparatus within the mobile provisioning system. Artificial intelligence algorithms may be used in the generation and optimization of models.

The systems that the mobile provisioning system has may be powered by a power system capable of providing power to operate at least the drive system, the navigation system, the control system, and the materials provisioning systems of the mobile provisioning system. In some examples multiple power systems may be present in a mobile provisioning system.

In some examples, the mobile provisioning system may also comprise a vision system. The vision system may be operant to create a digital model of the topography of a surface in a region proximate to the mobile provisioning apparatus. A controller located within the mobile provisioning system may initiate the operation of the vision system and may receive signals in response to the metrology that the vision system performs. In other examples, the mobile provisioning system may communicate with a vision system that is located external to itself or on another mobile provisioning system for example. Any of these vision systems may provide their digitized data to systems operating artificial intelligence algorithms which may enhance pattern recognitions effectiveness and also operational speed.

In some examples, the mobile provisioning system may also comprise a material storage system capable of storing at least a first material to be supplied to the plant support systems. The stored material may include solids, powders, gels, liquids, or gases, to mention some non-limiting examples. The material storage system may maintain a storage condition for the material by controlling an environmental condition. The condition that may be controlled may include one or more of temperature or pressure of the material.

In some examples, the mobile provisioning system may also comprise a communication system that may be capable of transmitting signals outside the mobile provisioning apparatus. In some examples users may use communications systems external to the mobile provisioning system in transmitting a control signal or control signals to the mobile provisioning system. The communication system may also be capable of receiving signals originating outside of the mobile provisioning apparatus. In some examples, the signals transmitted or received may comprise one or more of radiofrequency signals, infrared signals, optical signals or sound-based signals or emissions as non-limiting examples. In some examples the communication system may function to sense the environment of the mobile provisioning apparatus. A communication protocol through the communication system may involve the use of artificial intelligence techniques that may be operating either or both at the unit or remote from the unit. A team of mobile provisioning systems may communicate with a local processing node which may perform artificial intelligence techniques. Alternative one or all of the processing systems of the mobile provisioning system, a team of mobile provisioning systems, a local processing node or a remote processing node may act with artificial intelligence techniques. Sensing may occur in addition to signal transmission function. In some examples, there may be multiple communication and/or sensing systems within a mobile provisioning system.

There may be numerous methods related to a mobile provisioning apparatus. In some examples a user may transmit a signal to a mobile provisioning system which may include any of the types of examples of apparatus that have been described. The transmitted signal may cause the mobile provisioning system to next provision a first plant support system. The mobile provisioning system may, in continued response to the initial signal, move from a first location to a second or different location. After moving the mobile provisioning system may in further continued response to the initial signal provision a second plant support system.

In some examples, the methods may additionally include omnidirectional drive system aspects.

In some examples, the apparatus may include artificial intelligence processing capability. The artificial intelligence system may operate as a discrete or separate system or may be a sub-system of the general controller of the mobile provisioning system. In some examples, the artificial intelligence system may include an artificial intelligence chip, circuit board or assembly which may be customized to interface with some or all of the systems of a mobile provisioning system.

Implementations may include special forms of drive systems that allow for omni-directional movement. This may include wheel systems that allow for linear movement at any or many possible angles with respect to the center of mass of the apparatus. This may also include drive systems that turn with no turning radius, allowing for full orientation of the apparatus at any angle of rotation with respect to the center of mass of the apparatus. If these two characteristics are combined in a drive system, the exemplary drive system may be able to move in a particular linear path over a surface while, at the same time, changing its rotational orientation. Combining this exemplary drive system with a distribution system that is fixed to the drive system but operant outside of the area between or under the components of the drive system, this distribution system may be guided in a particular path over a surface that allows this distribution system to cover the entire surface it is passing over without the area between or under the components of the drive system ever passing over any area that was already distributed upon. This creates a completely novel manner of controlling mobility in a mobile provisioning robot.

Implementations may include rails, tracks, aerial conveyance of the system (such as with quad-copter rotors as a non-limiting example), or other possible drive system conveyance capabilities beyond wheels.

In some examples, a plant support system may automate the watering process for plants. It may integrate a water reservoir directly into the plant support system, configured to support a consistent water supply. An active sensor may continuously monitor substrate moisture levels and provide real-time data to a programmable control element. This programmable control element may analyze the sensor data and subsequently manage water delivery by controlling at least one fluid control element through a pump, which may may draw water from the reservoir. The water delivery system may support even distribution of water over the soil surface, while a drainage screen may prevent sediment build-up and allows excess water to return to the reservoir. The plant support system's modular design may comprise a planter module, a circuit box, and a water basin, which may allow for customization and maintenance.

In some examples of this plant support system there may be additional functionality and adaptability. In some examples, the sensor may measure resistance between sensor prongs to detect substrate moisture levels, providing accurate readings. In some examples, an issue of sensor corrosion may be dealt with by configuring the programmable control element to limit sensor activity, thereby extending the sensor's lifespan. In some examples, the device may include an overflow protection mechanism via a drainage outlet, configured to reduce likelihood of overfilling, and configured to support the safety of both electronics and soil. In some examples, configurations with adaptability may include a complete self-contained plant support or an insert for retrofitting existing planters.

Further enhancements of the plant support system's capabilities may include a water level indicator using a bobber system, providing users with a visual cue of the reservoir's water level. In some examples, the device may include examples where the water delivery system distributes water evenly across the soil surface, optimizing water usage. In some examples, the device may include connectivity aspects by incorporating a mobile app that connects to the system via Wi-Fi or Bluetooth, allowing users to monitor and control the plant support system remotely. In some examples, the device may include examples where the plant support system is enabled to use the programmable control element to adjust watering schedules based on plant species, growth cycles, and environmental factors, configured to support optimal plant care. In some examples, the device may include a camera for plant health diagnostics, offering users insights into their plants' well-being.

In further examples, there may be design aspects that allow for the water reservoir to be refilled by an autonomous device, reducing manual intervention. In some examples a system may include the self-watering plant support system and a modular connection for multiple planters sharing a single water source, promoting efficient water usage. In some examples, the system may enhance the sensor's capability by enabling deeper sensing of substrate moisture. In some examples, the system may include a relay to switch the pump on and off, providing precise control over water delivery. In some examples, the system may configure the programmable control element to provide reminders for fertilizer addition based on plant needs, configured to support comprehensive plant care. In some examples, the system may replace a bobber system with an electronic water level sensor for a more seamless design. In some examples, the system may integrate an Algorithmic processing subsystem to diagnose plant health issues or conditions indicative of plant stress based on visual and environmental data. In some further examples, the system may include modular components to enhance ease of servicing and replacement of components, which may include, in a non-limiting sense, the sensor and pump.

Another set of examples of a smart watering system may include a plant support system designed to retrofit existing planters, making it a versatile solution for plant care. This system may include a plant support system insert with an integrated active sensor to monitor substrate moisture levels. The programmable control element, housed within a circuit box, may analyze data from the sensor and manages water delivery. A pump may draw water from a reservoir and provide it to a water delivery system to distribute the water evenly over the soil surface. The system may also feature a drainage screen to prevent sediment build-up and allow excess water to return to the reservoir. A water level indicator may provide an intuitive indication of the water level in the reservoir, configured to support users are informed of the system's status.

Another set of examples of a smart watering system may include a plant support system with integrated AI and IoT capabilities, offering advanced plant care solutions. The system may include a water reservoir, an active sensor, and a programmable control element to manage water delivery. A pump may draw water from the reservoir, and a water delivery system may support even distribution over the soil surface. A drainage screen may prevent sediment build-up and allow excess water to return to the reservoir. The Algorithmic processing subsystem may analyze changes in substrate moisture over time and adjust watering schedules based on plant species, growth cycles, and environmental factors. The IoT module may connect to a mobile app via Wi-Fi or Bluetooth, allowing users to view historical data, input notes and photos, and adjust watering schedules, providing a comprehensive and user-friendly plant care experience. In some examples, artificial intelligence processing or algorithmic processing may map sensed input data to control outputs using trained models, rule-based inference, statistical learning, or combinations thereof, without requiring disclosure of a specific algorithmic implementation.

In some examples, the plant support system may be defined by a foundational automation architecture comprising a power subsystem, a programmable control subsystem, at least one fluid access mechanism, and at least one substrate sensing mechanism. The programmable control subsystem may be configured to coordinate electronic and electromechanical components based on stored instructions and real-time sensor inputs. Power may be supplied by internal energy storage, external wired connections, or combinations thereof, and may be actively managed to support continuous operation, intermittent duty cycling, or low-power standby modes. This architectural abstraction allows the plant support system to function as a programmable automation platform rather than a fixed-function watering device.

In some examples, modular components of the plant support system may include mechanical alignment features that facilitate repeatable attachment, detachment, and servicing of system modules. Such alignment features may include keyed interfaces, mating geometries, guide rails, detents, magnets, or tapered surfaces configured to promote correct positioning during assembly or docking. These alignment features may cooperate with electrical contacts or fluid interfaces to support reliable connection without requiring fine manual adjustment by a user. In systems interacting with autonomous devices, the alignment features may also increase tolerance to positional error during docking events.

In some examples, the plant support system may be configured to operate independently of a specific water source type by abstracting water access as a functional interface. Water may be supplied from an integrated internal reservoir, a remotely located shared reservoir, a pressurized external supply, or other fluid sources without requiring modification to the core control logic. The control system may manage variations in pressure, flow rate, or availability associated with different water sources. This abstraction enables deployment of the plant support system across residential, commercial, and industrial environments with minimal structural change.

In some examples, artificial intelligence processing may be employed not only for analysis and recommendation but also for direct control of system components. Artificial intelligence algorithms may generate control outputs that directly actuate pumps, valves, or other electromechanical devices based on learned models of plant behavior and environmental response. Such control may occur in real time or near real time, enabling adaptive responses to changing substrate or environmental conditions. Artificial intelligence processing may be implemented locally, at an edge-processing module, or through distributed processing architectures.

In some examples, sensing subsystems may be designed with explicit consideration of sensor lifecycle and long-term reliability. Sensor activation may be duty cycled or selectively enabled to reduce corrosion, material degradation, or energy consumption. The control system may track cumulative sensor usage, exposure conditions, or degradation indicators and adjust operating parameters accordingly. By treating sensor longevity as a design constraint, the plant support system may maintain accuracy and reliability over extended deployment periods without frequent sensor replacement.

In some examples of this smart watering system, the system may include a self-watering plant support system that incorporates an autonomous robotic system (hereafter also called a mobile provisioning system) for water refills, enhancing automation and convenience. The system may include a water reservoir, an active sensor, and a programmable control element to manage water delivery. A pump may draw water from the reservoir, and a water delivery system may distribute water evenly over the soil surface. A drainage screen may prevent sediment build-up and allows excess water to return to the reservoir. The modular design may comprise a planter module, a circuit box, and a water basin. The mobile provisioning system may be configured to deliver water refills to the reservoir when needed, reducing the need for manual intervention and configured to support a consistent water supply.

In some examples of this system, there may be enhancements of the system's functionality and user experience. In some examples, the system may configure the programmable control element to communicate with the mobile provisioning system to request water refills when the reservoir's water level falls below a predetermined threshold. In some examples, the system may include the introduction of an IoT module that may connect the smart plant support system to a mobile app via Wi-Fi or Bluetooth, allowing users to monitor and control the watering system remotely. In some examples, the system may include examples where the mobile provisioning system may receive water refill requests from the plant support system via a wireless communication protocol, configured to support seamless operation.

Further examples of this system may include examples which enable the mobile app to send notifications to the user when the water reservoir requires a refill, keeping users informed. In some examples, the system may provide real-time updates to the mobile app regarding the water level in the reservoir and the status of the mobile provisioning system. In some examples, the system may equip the mobile provisioning system with sensors to navigate to the plant support system and deliver the required amount of water to the reservoir. In some examples the system may allow users to manually override the mobile provisioning system's water delivery schedule via the mobile app, offering flexibility and control. In some examples, the system may log historical data on water refills and substrate moisture levels, accessible via the mobile app, providing users with valuable insights. In further examples, the system may enable the mobile provisioning system to communicate with multiple plant support systems within a designated area, managing water refills efficiently. In some examples, the system may provide users with diagnostic information about the plant support system's performance and the mobile provisioning system's activities through the mobile app. In some examples, the system may integrate the IoT module with other smart home devices to optimize the watering schedule based on environmental conditions.

There may be other examples of this smart part system such as an example which may support the mobile provisioning system may recharge itself at a docking station when not in use, maintaining its operational readiness. In some examples, the system may configure the programmable control element to send alerts to the mobile app if the mobile provisioning system encounters an obstacle or fails to deliver water, configured to support prompt user intervention. In some further examples, the system may allow users to set custom watering schedules and preferences via the mobile app, tailoring the system to their specific needs. In some examples, the mobile provisioning system may perform routine maintenance tasks, such as cleaning the drainage screen, configured to support optimal system performance. In some examples, the system may provide users with recommendations for plant care based on data collected from the plant support system and the mobile provisioning system, enhancing plant health management. In still further examples, the system may support firmware updates for the programmable control element and the mobile provisioning system, configured to support continuous improvement and the introduction of new features.

### Exemplary Unified Automation Stack Definition

In some examples, the plant support system may be defined by an automation stack comprising a power source, a programmable control element, a mechanism for accessing or delivering water, and at least one soil or substrate sensing component. This automation stack may represent the threshold at which a plant support system transitions from passive or manual operation to autonomous or semi-autonomous operation. The automation stack may serve as a foundational abstraction upon which additional optional features are layered.

In some examples, the invention may be framed as a system architecture rather than as a single fixed product configuration. The architecture may define relationships between modules, control logic, sensing elements, and actuation mechanisms, while allowing specific implementations to vary. This architectural framing may enable the plant support system to support different configurations, optional features, and deployment scenarios while remaining within a single inventive concept. In some examples, the architecture may be characterized by clearly defined interfaces between subsystems that permit modular expansion or reduction.

### Alignment-Aware Autonomous Refill Interfaces

In some examples, the plant support system may include an interface specifically configured to support autonomous refilling or servicing by a mobile provisioning system. The interface may include mechanical alignment features, visual markers, sensor-detectable features, or combinations thereof that assist an autonomous system in locating, orienting, and engaging with the plant support system. These features may be designed to tolerate positional error, angular misalignment, or environmental variability during approach and docking. The alignment-aware interface may thereby increase reliability and reduce failure rates during autonomous refill or service operations.

In some examples, alignment awareness may be achieved through passive mechanical features that reduce computational requirements for the mobile provisioning system. In some examples, active sensing elements may cooperate with mechanical features to dynamically correct alignment during docking. Such interfaces may be used for water refilling, nutrient replenishment, power transfer, data exchange, or combinations thereof, as non-limiting examples.

### Control-Layer Artificial Intelligence Versus Sensor-Layer Artificial Intelligence

In some examples, artificial intelligence functionality may be separated into distinct layers, including a sensor-layer artificial intelligence and a control-layer artificial intelligence. The sensor-layer artificial intelligence may be configured to interpret raw sensor data, detect patterns, or infer plant or environmental conditions. The control-layer artificial intelligence may be configured to generate direct control actions, such as actuating pumps, valves, or other electromechanical components. This separation may allow each layer to be optimized independently while cooperating within a unified control framework. In some examples, control-layer artificial intelligence may operate under real-time or near-real-time constraints, while sensor-layer artificial intelligence may operate asynchronously or over longer time horizons. The layered approach may improve system robustness by being configured to reduce likelihood of sensor interpretation errors from directly causing unsafe control actions.

### Commercial-Scale Abstraction Without Product Limitation

In some examples, the plant support system may be abstracted such that scale is treated as a parameter rather than as a defining product characteristic. The same underlying system architecture may be deployed for single-plant residential use, multi-plant garden use, or large-scale commercial or greenhouse environments. Some examples may allow for differences in scale to be accommodated through parameter adjustment, duplication of systems and/or system elements, modular replication, or shared infrastructure rather than through fundamentally different system designs. In some examples, scaling parameters may include reservoir capacity, sensor density, control granularity, or provisioning frequency. Shared resources such as mobile provisioning systems or centralized data, power, or water services may support multiple plant support systems at different scales. This approach may simplify manufacturing, deployment, and maintenance across diverse applications.

### Examples of Different Configurations.

In some examples, the disclosed autonomous plant support system may be configured to provide automated care through a combination of sensing, control, fluid handling, and modular interconnection. The system architecture is intentionally designed to support a range of deployment scenarios, including single-plant installations, multi-plant groupings, and larger commercial or nursery-scale environments. Power delivery, water delivery, sensing, and control functions may be implemented as integrated components or as distributed elements depending on installation constraints, scalability objectives, and user preferences. The following figures illustrate exemplary configurations that collectively demonstrate these architectural principles.

In some examples, the system architecture further supports incremental growth and reconfiguration over time. A user may initially deploy a single unit and later expand the system by adding additional units, modular components, water sources, or power sources without requiring redesigning the original installation. This flexibility enables long-term adaptability and supports evolving plant care needs across residential, commercial, and institutional settings.

As used herein, the terms “autonomous plant care system,” “autonomous plant support system,” “smart plant support system” and “plant care system” may be used interchangeably unless the context clearly indicates otherwise. Similarly, “main system body,” “system unit,” and “plant support unit” may refer to the same general structural component.

In some examples, modular hookups may dynamically function as inputs, outputs, or bidirectional interfaces for fluids, power, or data, with operational roles determined by connection state, control logic, or sensed conditions.

Unless otherwise specified, movement of water or other fluids may be driven by pumps, gravity, pressure supplied by an external source, pressure exerted by other fluids/gasses/vacuum, strategic use of geometries/diameters in piping or other forms of conduit, capillary action, or combinations thereof. Different types of pumps may be used in exemplary systems using pumps for movement of water or other fluids, including as non-limiting examples auto-siphon pumps, peristaltic pumps, submersible pumps, or others.

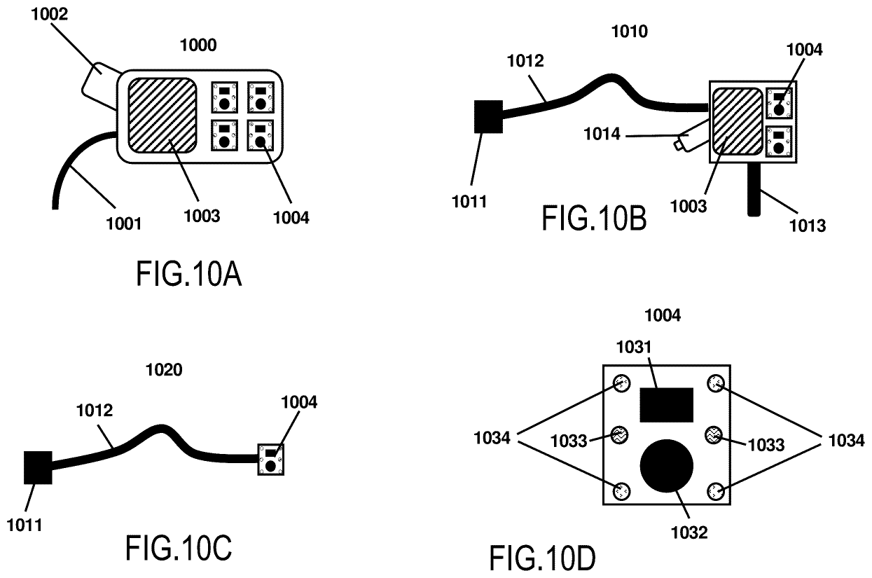

Referring now to FIG. 10A, a main system body 1000 is illustrated, which functions as the central hub of an autonomous plant care system. In some examples, the main system body 1000 may be responsible for receiving external resources and coordinating downstream system operation. In some examples, the main system body 1000 may function on its own as the only system body to provide autonomous care of plants.

In some examples, the main system body 1000 may be intended to consolidate resource inputs and high-level coordination functions, while allowing plant-level sensing and actuation to be distributed away from the central unit.

The main system body 1000 may include a power source 1001 that supplies electrical power to the system and a water input 1002 that supplies water from an external source such as a spigot or other pressurized water connection. These exemplary inputs may allow the system to operate continuously without requiring frequent manual replenishment.

An electronics module 1003 may be provided within the main system body 1000. This electronics module 1003 may include power management circuitry, processing and control logic circuitry, communication interfaces, user input/output components (for example display screens, buttons, touch screens, switches, or others), or other electrical components. The electronics module 1003 enables centralized control of sensing, decision-making, and actuation throughout the system. In some examples, the components of the electronics module may be distributed throughout the device, rather than being housed together in a single discrete module or box.

The main system body 1000 may further include multiple modular hookups 1004. These modular hookups 1004 form modular interfaces that may allow one or more downstream units to be connected. The modular hookups 1004 may support expansion of the system by allowing additional components to be added in series or in parallel, depending on the user's installation needs. In some examples, a main system body 1000 may have more or fewer modular hookups 1004 than are shown in this figure.

In some examples, this modular interface approach may allow users to incrementally expand or reconfigure the system over time without replacing the main system body 1000, supporting a range of installation sizes and layouts. In some examples, this modular interface approach may allow users to adjust the placement of the main system body 1000 while expanding or reconfiguring the system with additional components, while achieving the same or improved functionality (this may be desirable for improved aesthetic appeal, refined placement of sensors, easier or more-ergonomic access to components, or other reasons based on the desires of the user).

Referring now to FIG. 10B, an active chain unit 1010 is illustrated which may be configured to connect to the main system body 1000 or to another upstream chain unit. The active chain unit 1010 may extend sensing and plant care functionality into a grow bed or planting area, in some examples.

The active chain unit 1010 may include a modular connector 1011 that interfaces with a modular hookup 1004 of the main system body 1000 or another chain unit. The modular connector 1011 may convey one or more of electrical power, data signals, water, nutrients, or other materials, depending on the system configuration. In some examples, additional functions may be incorporated into the modular connector 1011.

A transmission conduit 1012 may be provided to carry these resources through the unit. The transmission conduit 1012 may include electrical cables, fiber optic cables, fluid tubes, or combined structures capable of transmitting power, data, and fluids, as non-limiting examples.

An electronics module 1003 may be located within the active chain unit 1010. This electronics module may include local processing, control logic, and user input/output capability. In some examples, the active chain unit 1010 may perform local decision-making based on sensor inputs, while in other examples it may receive commands from the main system body 1000 (or other active chain unit/units 1010) based on sensor input data it has transferred to the main system body 1000 (or other active chain unit/units 1010).

This distributed processing capability may allow different active chain units to operate semi-independently, enabling localized control decisions while still participating in a coordinated system-wide strategy. As another non-limiting example, this distributed processing capability may allow for the main system body 1000 to process a greater scale of informational context provided by downstream data gathering and make system-wide or localized control decisions accordingly. As another non-limiting example, this distributed processing capability may allow for the main system body 1000 to process a greater scale of informational context provided by downstream data gathering, and make system-wide (with an exemplary master-slave configuration between the main system body 1000 and downstream components, respectively, or with those roles reversed as non-limiting examples) or localized control decisions (with the main system body 1000 performing its own localized plant care based on downstream data as well as internal data) accordingly.

The active chain unit 1010 may include a modular hookup 1004, allowing additional chain units to be connected downstream. This enables serial extension of the system or branching into parallel configurations.

Such serial and parallel chaining may enable flexible physical layouts, including linear extensions into long grow beds or branching arrangements serving multiple planting regions, as non-limiting examples.

A substrate sensor 1013 may be provided to collect data from a growth medium. The substrate sensor may measure moisture and, in some examples, other soil characteristics such as nutrient content or composition.

As discussed, the substrate sensor is not limited to moisture sensing and may be configured to collect additional growth-medium data, allowing the system to support a variety of plant types and substrates.

A water distribution element 1014 may be configured to distribute water supplied through the inlet connector to a localized region of the growth medium. The distribution may be tailored to specific plants proximate to the active chain unit 1010.

Referring now to FIG. 10C, a pass-through chain unit 1020 is illustrated that may function primarily as an extension element. The pass-through chain unit may be configured, in some examples, to transmit power, data, and fluids without incorporating full sensing or control functionality.

The pass-through chain unit may include a modular connector configured to interface with an upstream modular hookup and a modular hookup configured to interface with a modular connector of a downstream unit (or with flow directions reversed in a bi-directional configuration for example). By omitting active components, the pass-through chain unit may allow the system to be extended over longer distances in a cost-effective manner.

This approach may allow system reach to be increased without duplicating sensing or control hardware, reducing overall system cost while preserving expandability.

In some examples, the pass-through chain unit may include signal conditioning, pressure boosting, nutrient provisioning, or signal repeater functionality to maintain reliable transmission over extended lengths.

Such functionality may support longer physical installations where attenuation of signals or fluid pressure may otherwise limit system performance.

In some examples, exemplary chain units 1010 or 1020 may have more or fewer modular connectors 1011 or modular hookups 1004 than are shown in these figures, or different configurations (such as a pass-through chain unit 1020 with multiple modular connectors 1011, as a non-limiting example).

Referring now to FIG. 10D, a detailed view of a modular hookup 1004 is provided, illustrating exemplary interfaces used to connect modular system components.

The outlet hookup may include electrical data and power interface elements 1031 and fluid interface elements 1032 for water and/or nutrients. These interfaces may be implemented using pins, contacts, connectors, ports, fittings, or other suitable connection mechanisms.

Alignment features 1033 may be optionally included to guide proper mating between inlet connectors and outlet hookups. These features may reduce the likelihood of misalignment, and in some examples, may include keyed geometries or other poka-yoke mechanisms to prevent incorrect orientation during connection, reducing the risk of damage or improper system operation.

Mounting features 1034 may be provided to secure connected components together. These features may include mechanical fasteners, snap-fit elements, magnetic couplings, or other attachment mechanisms that provide strain relief and reduce the risk of accidental disconnection.

Secure mounting may be particularly important in real-world environments where cables or hoses may be subject to incidental pulling or movement.

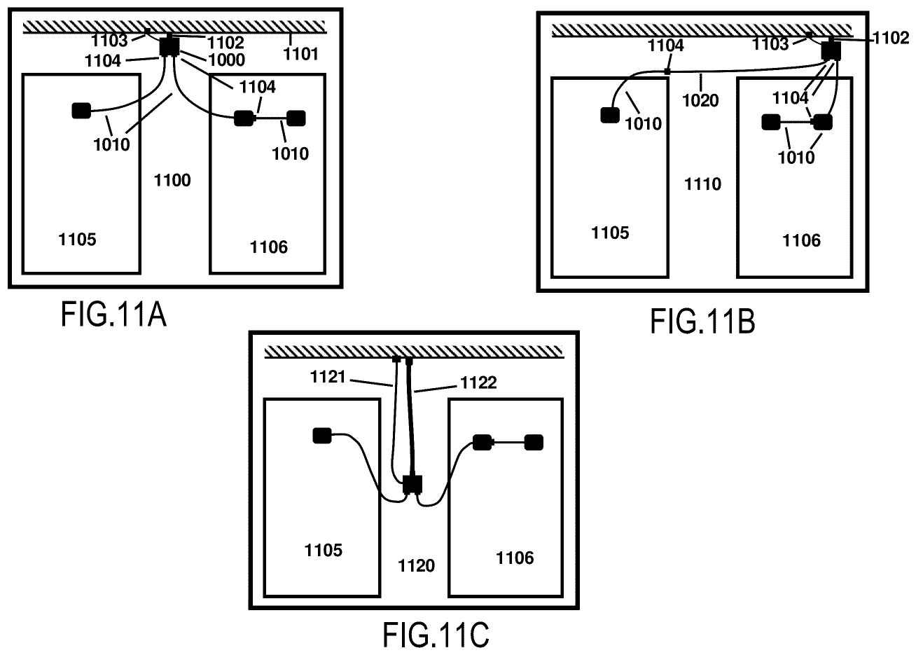

Referring now to FIG. 11A, an example system installation of a basic dual grow bed configuration 1100 is illustrated, which may include a main system body 1000 connected to a water source 1102 and an electrical power source 1103, and mounted near a wall surface 1101. There may be completed modular connections 1104 between the main system body 1000 and downstream active chain units 1010.

Two active chain units 1010 may extend from the main system body 1000 into two separate grow beds. A first grow bed 1105 may include a single active chain unit 1010, while a second grow bed 1106 may include multiple active chain units 1010 connected in series to extend coverage deeper into the grow bed.

This configuration illustrates how a single main system body 1000 may simultaneously support multiple planting areas with differing depth or coverage requirements.

Referring now to FIG. 11B, an alternative exemplary configuration 1110 is illustrated in which an extension chain unit 1020 may be used to extend the reach of the system. This configuration may be useful when grow beds are positioned farther from the main system body 1000, water source, and/or power source, or when routing constraints require additional distance. As in the example of FIG. 11A, the dual bed system may be configured with components as described therewith. It may be noted that the additional extension chain unit 1020 may result in an additional completed modular connection 1104 as illustrated down-stream of the additional chain unit 1020.

In general, extension chain units 1020 may be particularly useful where physical constraints or aesthetic considerations limit placement of the main system body 1000 near the plants. It should be noted that autonomous plant support by the example systems 1100 and 1110 may be equivalently provisioned, though the specifics of their construction vary based on user preference. The straightforward plug-and-play connectivity and control of the autonomous plant support system may empower the user to customize the system to their needs, even if they do not have any or substantial experience with engineering, plant care, or other related fields of technical experience.

Referring now to FIG. 11C, an exemplary remotely-located configuration 1120 is illustrated in which the main system body 1000 may be positioned remotely away from wall-mounted utilities. A water hose 1122 may connect the main system body 1000 to a more remotely located water source, and an extension power cable 1121 may connect the main system body 1000 to a more remotely located electrical outlet. In some examples, the user may desire to use existing equipment that they own as part of the system (such as the water hose 1122 or extension power cable 1121 of the FIG. 11C example) rather than buy new components. In these examples, a main system body 1000 or modular chain units may be configured with modular attachment points for standard equipment or standard interfaces. As a non-limiting example this may include an industry-standard threaded hose fitting at the water output, so that a user may attach their own sprinkler system or other farm watering equipment as water distribution for the system.

This configuration may provide flexibility in placement of the main system body 1000 relative to plant and utility locations.

In other examples, equivalent functionality may be achieved by a main system body 1000 configuration that provides longer integrated hoses or power cables, rather than separate extension elements 1121 and 1122.

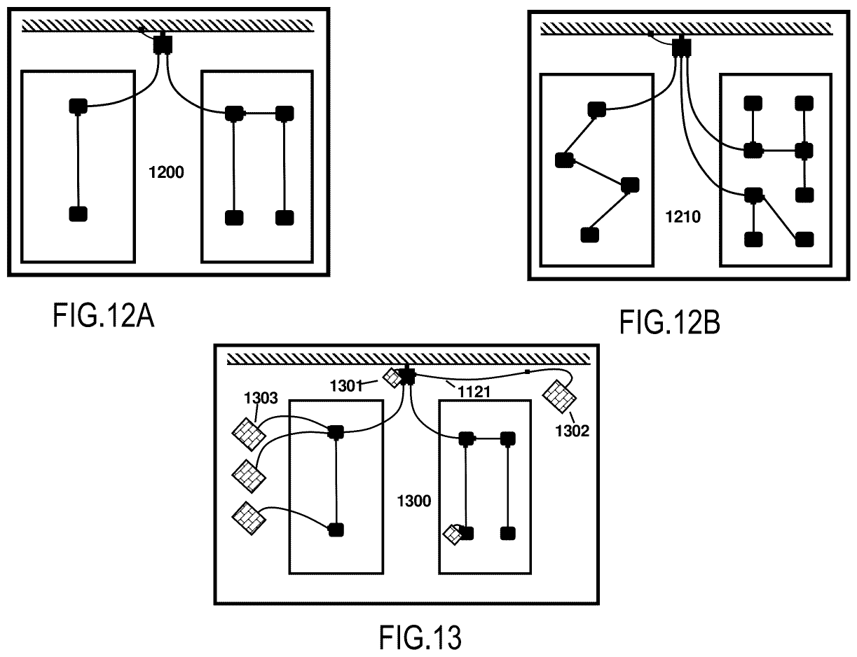

Referring now to FIG. 12A, a system in which additional active chain units 1010 are added 1200 is illustrated, which may be utilized to further distribute sensing and plant care capability across a larger number of plants. Units may be connected in serial arrangements, in parallel arrangements branching from the main system body 1000 or other active chain units 1010, or in combinations of serial and parallel configurations.

Some of these examples may illustrate the system's ability to scale incrementally as overall plant count, number of different types of plants, or coverage requirements increase.

Referring now to FIG. 12B, an alternative expanded configuration 1210, is illustrated in which multiple active chain units 1010 are arranged to provide individualized care to different plant groupings. In some non-limiting examples, serial chains may be used for plants requiring localized sensing, while parallel chains may be used to distribute water to broader areas.

Such configurations may be particularly advantageous where different plants exhibit varying watering or care requirements within the same installation.

As illustrated, some exemplary system architecture configurations may be defined with a system architecture that may include a power input 1001 configured to receive electrical power from a removable cable, a wall adapter, a renewable energy source, or a shared power bus. The power input 1001 may supply power to control electronics, sensing components, communication circuitry, and fluid-handling elements. In some examples, modular hookups 1004 may be provided to enable interconnection between system components, allowing the system to scale beyond a single plant support unit.

In some examples, the modular hookups 1004 may be selectively coupled to form completed modular connections 1104. The completed modular connections 1104 may function as inputs, outputs, or bidirectional interfaces, thereby enabling chaining, branching, or networked configurations of multiple plant support systems. This modular approach may allow water, power, and data to be routed flexibly throughout the system while minimizing the need for fixed wiring or plumbing layouts. It may be important to note with these examples that endless permutation possibilities may exist to combine any number of main system bodies or chain units to comprise an exemplary autonomous plant support system. The examples of FIG. 12A and FIG. 12B each show just one main system body 1000, but configuration possibilities may allow for multiple main system bodies configured in a single connected system. Some examples may also include separate systems that become interconnected through connection of main system bodies or chain units, which may then be able to share data and resources like power or water, whether they continue to function independently, or they become interconnected into a new larger networked system.

In some examples, different system components may be configured with different levels of capability for the purpose of preventing redundancy of components for an efficient and cost-effective system. Using FIG. 12B as a non-limiting example, the serially connected string of active chain units 1010 may be such where the water source supplies water at pressure, so the 1^{st}, 3^{rd}, and 4^{th} active chain units 1010 may not possess pumps, but rather valves to control delivery of water; in this example, the distance between the water source and further chain units may be such where a pump is used in the 2^{nd} active chain unit 1010 of the string to re-increase water pressure to be sufficient for the 3^{rd} and 4^{th} chain units downstream.

Referring now to FIG. 13, an exemplary solar power configuration 1300 is illustrated. In some examples, the system may include a solar panel 1301 mounted on a main system body to provide localized power generation. This configuration may be advantageous when grid power is unavailable or undesirable. In other examples, a remotely positioned solar panel 1302 may be coupled via a power extension 1121, allowing the solar panel to be placed in a location with improved exposure to sunlight while the main system body remains in a separate location such as for example, closer to plants, closer to the water source, or other possible reasons.

In some examples, solar power from a solar panel 1303 may alternatively be introduced through an active chain unit. This distributed power injection approach may allow energy generated at one location to be shared across multiple interconnected units. Power storage elements, such as batteries, may be integrated within one or more main system bodies or chain units to support operation during periods of limited solar availability.

In some examples utilizing solar panels or other hardware for gathering solar power, data from power generation metrics may be used by the system as sunlight sensing data for algorithmic processing for autonomous plant care.

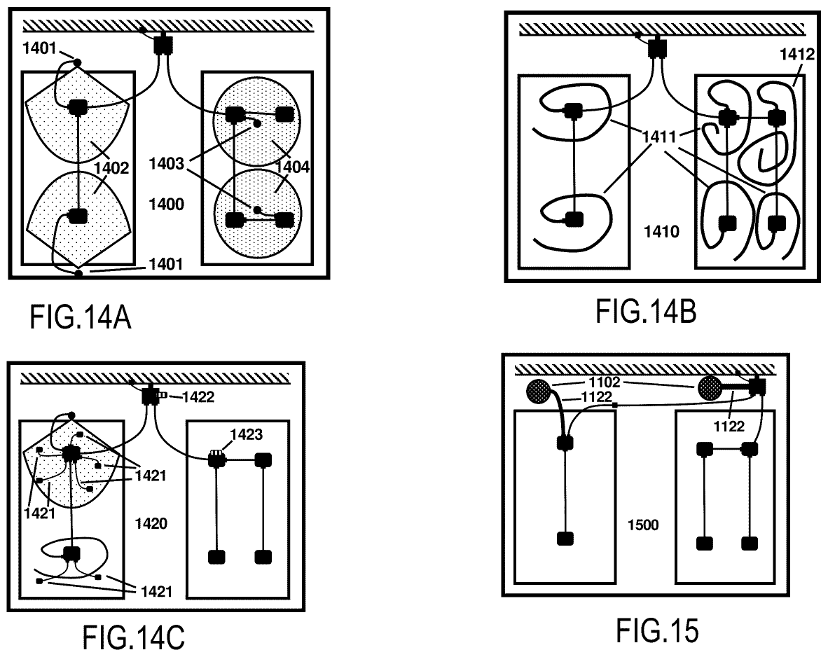

Referring now to FIG. 14A, exemplary sprinkler-based water distribution systems 1400, are illustrated. In one example, sprinklers 1401 may be positioned outside of a grow bed to spray inward 1402. In a second example, sprinklers 1403 may be positioned within a grow bed to distribute water radially 1404. In the example where sprinklers are positioned within the grow bed, the sprinklers 1403 are shown as separate units connected to and controlled/provisioned by an active chain unit via a modular connection; this may be desirable to place sensors and the sprinkler in separate locations, for system optimization. As another example, an active chain unit may be configured to have a connected sprinkler 1403 built-in to the unit. This may be desirable, as one non-limiting reason, in order to have fewer overall number of components in the system.

The illustrated sprinkler configurations may represent non-limiting examples of how water distribution may be adapted to different planting geometries.

Referring now to FIG. 14B, exemplary drip line configurations 1410, are illustrated. A drip line 1411 may be positioned proximate to an active chain unit, while an extended drip line 1412 may distribute water to a larger area of a grow bed. Water delivery may be controlled based on sensing data associated with each chain unit.

In some examples, sensing data from a localized region may be used to represent or estimate conditions of a broader area when plant types and growth media are substantially similar.

Referring now to FIG. 14C, exemplary configurations for additional sensors and nutrient provisioning 1420, are illustrated including additional substrate sensors 1421 positioned throughout a grow bed to provide more granular sensing data. A nutrient trough 1422 may be included on the main system body 1000 or on an active chain unit to store and dispense nutrients in some examples. Such a component may be built-in to the configuration of the main system body 1000 or active chain unit, or it may be modularly added in other exemplary configurations.

Placement of nutrient troughs at different points in the system may allow selective nutrient delivery to specific planting regions without affecting others. In some examples, alternative form factors may be used to deliver nutrients to the system. This may include sealable fill ports for liquid fertilizer, or customized modular attachment points for filled nutrition capsules, as non-limiting examples. Exemplary nutrition capsules may be partially or fully filled with solid form or fluid form nutrients, and in some examples may be filled by a user or purchased pre-filled. In some examples as a system with attached nutrition capsules is operant, fluid may be mixed with the nutrients to dissolve the nutrients, and system function may not be hindered when the loaded supply of nutrients runs out.

Referring now to FIG. 15, alternative water sourcing options 1500 may include rain collection barrels as a water source 1102. In some examples, water supply connections 1122 may convey collected water from the barrel to the system, via a main system body 1000 or a chain unit. In some examples, rain collection barrels may be positioned within a grow bed, submerged in substrate, or below the ground around a grow bed, as non-limiting examples. Such an alternative water source may be used alone or in conjunction with other water inputs. Other alternative water sources may include desalinated salt water, nearby running water bodies such as streams or rivers, nearby larger water bodies such as ponds, reservoirs, or other volumes of fresh water, or other possibilities.

Multiple water sources may be used individually or in combination, allowing the system to adapt to user preferences or environmental conditions.

In some examples, system components may be mounted in place with various means. Components may be configured with recesses or set screws to mount on poles or posts, or they may be configured with bolt hole patterns to be fixed to walls, raised garden bed siding, posts, or other surfaces, or they may be configured with other possible fastening methods. In some examples, components with standard hose threaded fittings may be secured directly onto water spigots using this fitting connection. In some examples, an attached probe-type sensor may protrude into the substrate or ground which may act to help anchor the component in place. Other possible securing methods may be possible for securely mounting system components.

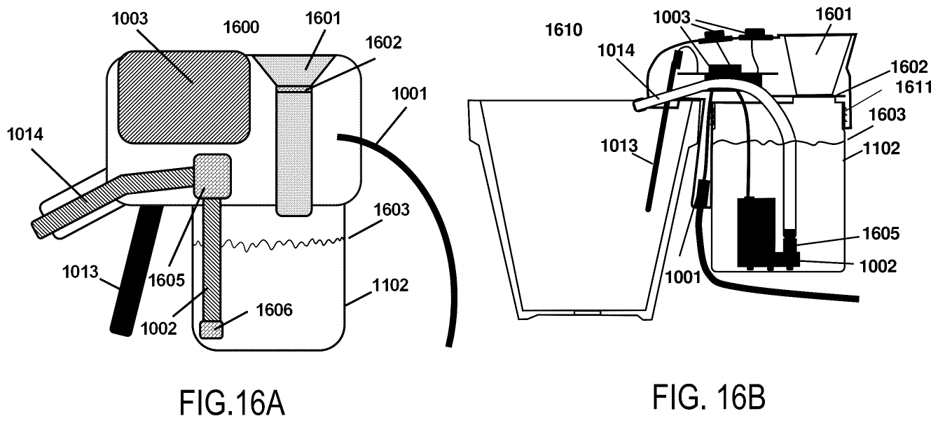

Referring now to FIG. 16A, an exemplary main system body 1600 is illustrated. In some examples, the main system body 1600 may be configured for placement within or on a plant pot and serves as a central integration point for sensing, control, communication, and fluid handling. The main system body 1600 may include an electronics module 1003 housing processing circuitry, memory, and communication interfaces, among other electronic components described previously in other examples. A substrate sensor 1013 may extend into the growth substrate to monitor moisture levels or other substrate conditions relevant to plant health.

In some examples, the main system body 1600 may further include an internal water source 1102 configured to store water and/or nutrient solutions. Water may be introduced through a filling port 1601, which may include a screen material 1602 to inhibit debris, contaminants, or pests from passing through. A fluid control device 1605 such as a pump or valve element may draw water via a water input 1002 and supply a water distribution element 1014 positioned to deliver water to the plant substrate.

In some examples, a filter 1606 may be positioned at a fluid inlet to protect pumps, valves, and distribution elements from debris. A sensed water level 1603 may be monitored using electronic or mechanical sensing techniques to support automated refill notifications, system diagnostics, or adaptive watering control. In some examples, an active water sensing apparatus may be forgone, and instead a visual indication of the water level may be achieved with a bobber, transparent material of the built-in water source 1102, or other possibilities so a water level indication may be seen by the user. In some examples, a power input 1001 may be connected to the apparatus to provide power to the unit. In other examples, other power sources such as batteries may be employed.

Referring now to FIG. 16B, an alternate sectional view of the main system body 1600 is illustrated. In some examples, the alternate sectional view demonstrates that internal components may be arranged in different spatial relationships while preserving system functionality. For example, the water source 1102 is depicted with threads 1611 that interface with the housing of the main system body 1600 for easy coupling, and the fluid control device 1605 depicted may be a pump of a submersible type, with a built-in water input 1002. This illustrates that the depicted arrangement is exemplary and that variations in internal layout may be employed to accommodate manufacturing constraints, pot geometries, thermal considerations, or serviceability requirements.

FIG. 16A and FIG. 16B demonstrate examples of an autonomous plant support system where the functional capabilities may be captured in a single main system body. While each particular example may not have modular hookups, or other hardware to expand capabilities or scale further (as explored in other examples), each may contain the baseline functionality required for an autonomous plant support system and may function on its own to support a growing vessel that it is installed into.

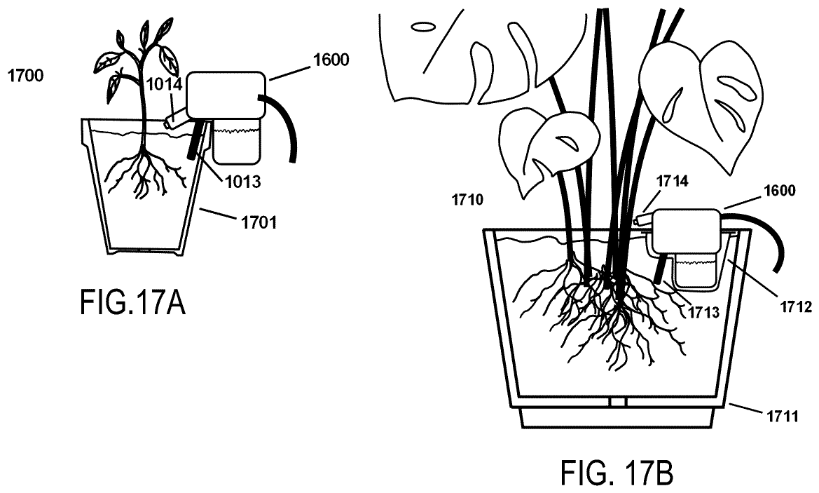

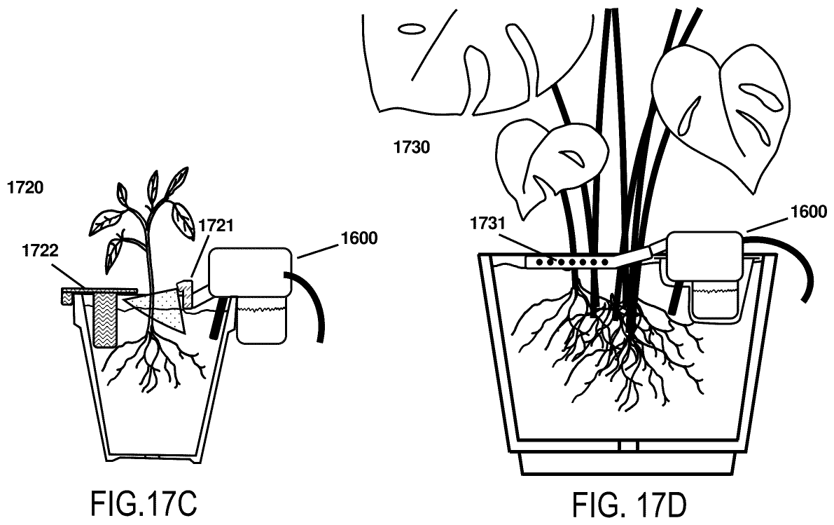

Referring now to FIGS. 17A and 17B, exemplary mounting configurations are illustrated. In some examples, referring now to FIG. 17A, a small pot mounting configuration 1700 may enable the main system body 1600 to be mounted on a small pot 1701. This configuration may preserve usable substrate volume while providing stable placement of system components proximate to the substrate. In some examples, a sensor 1013 may penetrate into the substrate surface while a water distribution element 1014 may provide water and other outputs such as nutrients to the substrate.

In some examples, the geometry of the main system body 1600 may be configured such that the main system body 1600 may be seatable on an upper edge or rim of a plant pot. The main system body 1600 may be supported by the pot edge while remaining stably positioned thereon. In such examples, the relative positioning of the center of mass of the main system body 1600, in combination with one or more contact features engaging the pot, may be selected to promote stable resting of the main system body 1600 on the pot.

In some examples, the main system body 1600 may include features configured to resist rotational or tipping moments, such as moments induced by gravitational forces acting on the center of mass. These features may reduce the likelihood of the main system body 1600 overturning, tipping inward into the pot, or tipping outward away from the pot, thereby maintaining positional stability during operation.

In some examples, the main system body 1600 may include one or more retention mechanisms configured to secure the main system body 1600 to the pot or other growing vessel. Such retention mechanisms may include, without limitation, frictional elements, fasteners, clamping structures, threaded engagement features, adjustable standoffs, or screw-actuated interfaces that are configured to apply outward pressure against an interior or exterior surface of the pot. In some examples, adjustable engagement elements may be rotatable or otherwise actuated to contact the pot and thereby secure the main system body 1600 in a desired position. In other examples, such retention mechanisms may be designed to secure to nearby surfaces or objects besides (or in addition to) the pot or growing vessel. A variety of mounting and seating approaches may be employed, and no single attachment mechanism is required.

In some examples, the seating and mounting arrangement of the main system body 1600 may be configured such that a substrate sensor may be positioned within the substrate of the plant pot to enable direct sensing of substrate conditions. In other examples, where a non-contact sensing modality is employed, the substrate sensor may be positioned proximate to the substrate in a manner sufficient to measure one or more soil or growth-medium characteristics without requiring physical contact.

In some examples, the seating arrangement may further position a water distribution element, nutrient distribution element, or other provisioning element in fluid communication with the plant growth medium. Such elements may be configured to dispense water, nutrients, or other resources to support autonomous or semi-autonomous plant care while the main system body 1600 remains supported by the pot.

In other examples, referring now to FIG. 17B. a large pot mounting configuration 1710 may enable the main system body 1600 to be mounted within a larger pot 1711 using a mounting and positioning case 1712. The mounting and positioning case 1712 may include passage 1713 allowing a substrate sensor 1013 to extend into growth media at a selected depth. Water distribution may occur via an elevated water distribution element 1714, positioned above the level of the substrate to distribute water to the substrate (or to be accessible for further user customization of the water distribution with added elements, as explored in other examples). As is illustrated, in some examples, the system may be configured such that at least a portion of the system may be mounted within the substrate of a plant pot. In such examples, one or more components of the system may be positioned below an upper surface of the substrate, such that the system may be at least partially supported by the substrate itself during operation. The mounting and positioning case 1712 aids in this placement, though it is an optional element.

Referring now to FIG. 17C, an example with components that may be used in configuring and installing an autonomous plant support system 1720 is illustrated. In some examples, a spray nozzle 1721 distributes water across a substrate surface to provide uniform wetting. In this example, the spray nozzle 1721 may be depicted as a modular element attached onto the distribution element of the system (this may be done by various means including friction-fit mating geometry, fasteners, flexure snaps, threads, or clips, as non-limiting examples). In some examples, such a spray nozzle may be built-in to a configured system. A potting and positioning tool 1722 may assist with installation and alignment of components during setup, planting, potting, or repotting of a plant. The element 1722 may be positioned to create and maintain a negative space or reserved volume within a plant pot during placement of the plant and surrounding substrate. In some examples, the element 1722 may be mountable to a sidewall or rim of the plant pot and may be configured to remain securely positioned during the planting or repotting process.

In some examples, the geometry of the element 1722 may be selected to be compatible with a variety of plant pot geometries and sizes. During planting or repotting, the element 1722 may occupy a defined volume within the pot such that plant material, including roots, may be prevented from entering that volume while substrate is added around it. Once the plant has been positioned and the user determines that the plant is securely supported by the substrate, the element 1722 may be removed from the pot, and the reserved volume may subsequently be backfilled with additional substrate.

In some examples, the reserved volume created by the element 1722 may be intended to provide a clear region of substrate suitable for subsequent insertion of a substrate sensor or other system component. By maintaining the reserved volume substantially free of plant roots or other obstructions, the risk of damaging plant material during insertion of a sensor—such as by puncturing, abrading, or stressing the plant or its roots—may be reduced.

In some examples, the geometry, size, and shape of the element 1722 may vary from the particular configuration illustrated in the figures. Such variations may be selected based on desired volume size, pot geometry, plant type, or system requirements, and may generally serve to maintain a region within the pot to be substantially free of plant material or other obstacles. Multiple such elements 1722 may be used during planting or repotting to create multiple viable mounting locations for the system, for purposes of rotating plants while maintaining system placement in a less prominently visible location, as a non-limiting example.

Referring now to FIG. 17D, an example is illustrated in which the system may be configured to provision water to a plant using an alternative drip-line distribution arrangement 1730. In some examples, an autonomous plant care system main system body 1600 may include a water distribution element configured to supply water to a drip line 1731.

In some examples, the drip line 1731 may be fluidly coupled to the water distribution element via a fitting provided on the water distribution element. Such a fitting may be configured to receive an end of the drip line and establish a sealed fluid connection. In other examples, alternative coupling mechanisms such as custom or industry-standard fittings like barbed, push-to-connect, threaded, or others as non-limiting examples may be employed to connect the drip line 1731 to the water distribution element 1730, and no particular attachment structure may be required.

In some examples, the drip line 1731 may include one or more apertures, emitters, or perforations positioned along its length to dispense water at selected locations. The placement, spacing, and size of such apertures may be produced by the manufacturer or may be selected by a user to control where water is delivered within the plant growth medium. This configurability may allow water to be supplied to specific regions of the plant or root zone according to user preference or plant requirements.

In some examples, the drip line 1731 may be secured to a mesh material that may be placed on top of the substrate. The mesh material may be composed in strips or as one sheet with selective cuts to fit around plant stems, as non-limiting examples. In some examples, the mesh material may have varying thickness or size of apertures or be an extension of a pot insert or part of a mounting and positioning case that allows water, water and nutrients, or other fluids to pass through. Securing the drip line 1731 to a mesh material with ties, clips, or other possible methods may help the drip line to maintain its desired routing shape and placement as shifts in water pressure act to deform the drip line from the user's configuration. The mesh material and drip line 1731 may be left on the surface of the substrate, secured to the plant, pot, insert, or other component of the system, or may be buried with substrate, as non-limiting examples.

In some examples, drip-line-based distribution may be advantageous for plants benefiting from localized or targeted watering, and a variety of water distribution apparatuses and configurations may be employed to customize water delivery without departing from the scope of the disclosure.

In some examples, alternate water distribution configurations may be selected based on plant species, substrate composition, container geometry, or user preference. These configurations demonstrate that the system is not limited to a single watering modality and may be adapted to diverse horticultural applications.

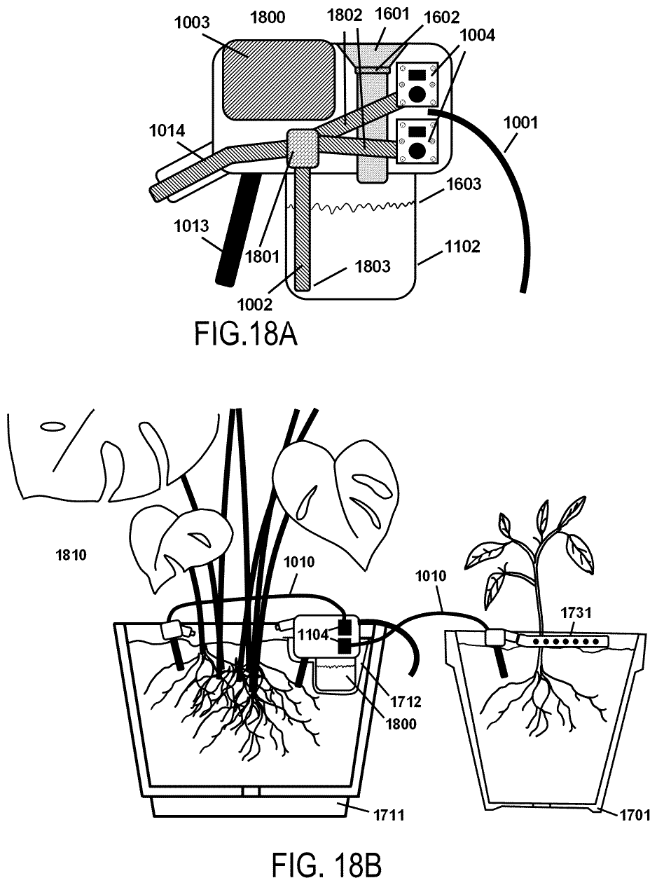

Referring now to FIG. 18A, an exemplary autonomous plant support system utilizing a main system body with a modular hookup and pump-manifold configuration 1800 is illustrated. In some examples, a pump in the assembly may act to pressurize and direct water in different directions, and a manifold assembly configured with multiple ports and other potential passive or active fluid re-directing or pressure regulating components, as non-limiting examples, may act to direct water from one of more possible inlets to one or more desired outlets. In some examples, an autonomous plant support system may be configured to function with a pump and manifold assembly to pressurize and direct water. In other examples, an autonomous plant support system may be configured to function with only a pump to pressurize and direct water. In some examples, the configuration may be implemented as part of an autonomous plant care system and may be similar in overall architecture to other system examples described herein, while incorporating an increased number of modular hookups 1004 provisioned for expanded functionality.

In some examples, a pump and manifold assembly 1801 may be housed within a main system body 1800. The pump and manifold assembly 1801 may be configured to draw or siphon water from a water source 1102 and to supply the water to one or more downstream components of the system. (In this example, the water inlet 1002 may be shown without an attached filter 1803, illustrating this as an optional feature for such a system.) In some examples, the pump and manifold assembly 1801 may supply water not only to an internal or built-in water distribution element 1014, but also to each of the modular hookups 1004.

Internal distribution conduits 1802 may be provided within the main system body 1800 to route water or nutrient solutions between the pump and manifold assembly 1801 and the modular hookups 1004. In this manner, the modular hookups 1004 may enable modular output configurations 1810 that supply water or other fluids to additional plant support units, auxiliary devices, or downstream system components.

In some examples, the pump and manifold assembly 1801 may be represented schematically or in simplified form for clarity, while in practice the assembly may include more complex hardware capable of supporting a relatively large number of modular hookups 1004. In some examples, operation of the pump and manifold assembly 1801 may be controlled by an electronics module 1003, enabling programmable or dynamic routing of fluids within the system.

In some examples, such control may allow individual modular hookups 1004 to function not only as fluid outputs, but also as fluid inputs to the system, thereby enabling bidirectional fluid flow, selective sourcing, or recirculation of water or nutrient solutions. Such configurations may support more advanced system architectures, as described in further examples herein.

Referring now to FIG. 18B, an example plant care system configuration 1810 is illustrated that utilizes the modular hookup capabilities of the system described with reference to FIG. 18A. In some examples, the system may include a main system body 1800 coupled to multiple active chain units 1010 via corresponding modular connections 1104.

In some examples, each active chain unit 1010 may include soil sensing capability and water distribution capability and may further include any of the additional components described herein with respect to active chain units. The active chain units 1010 may be fluidly and electrically coupled to the main system body 1800 through the modular connections 1104 to receive water, power, and control signals.

In some examples, the main system body 1800 may be positioned within a plant growth medium of a plant pot 1711. The main system body 1800 may be configured to operate while partially or fully submerged within the growth medium. In some examples, the main system body 1800 may be used in conjunction with a positioning or support structure 1712 configured to facilitate placement, stability, or repeatable positioning of the main system body within the growth medium. In other examples, the main system body 1800 may be operable without the use of the positioning structure 1712, and the positioning structure may be considered optional.

In the illustrated example, multiple active chain units 1010 may be positioned within the larger plant pot 1711 to provide increased soil sensing coverage and increased water distribution capability. The presence of multiple substrate sensors may allow collection of additional data representative of overall substrate conditions, while multiple water distribution elements may increase water throughput and spatial distribution within the pot. In such examples, water may be distributed through the active chain units without requiring separate drip lines or external distribution tools.

In some examples, an additional active chain unit 1010 may be routed from the main system body 1800 to a neighboring plant pot 1701. In such configurations, the additional active chain unit may provide soil sensing and water distribution to a plant located in the neighboring pot, using water and power supplied from the main system body 1800.

In the illustrated example, the additional active chain unit 1010 associated with the neighboring pot 1701 may further include a drip line 1731 coupled thereto, enabling customized or localized water delivery to the plant in that pot. The use of a drip line in this manner may allow water to be delivered to selected locations within the growth medium.

In some examples, the main system body 1800 may include additional modular hookups beyond those illustrated, allowing further active chain units or auxiliary devices to be connected. Such configurations may enable distribution of sensing and water delivery across a larger number of plants, or increased sensing density and water distribution within a smaller number of plants. The illustrated configuration is provided as one non-limiting example of many possible permutations enabled by the modular architecture.

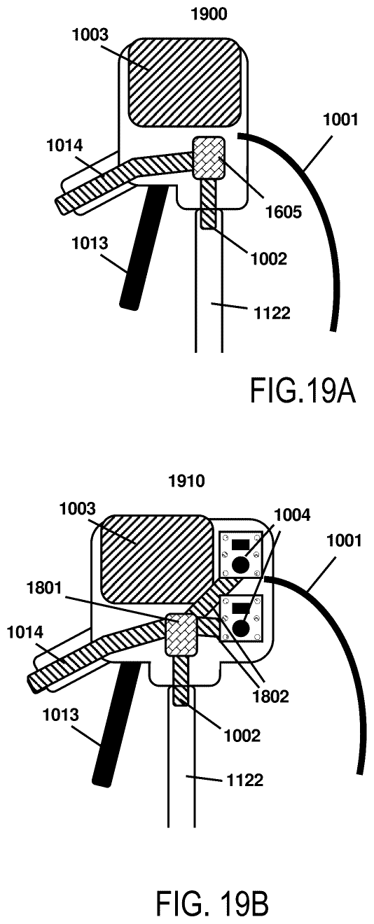

Referring now to FIG. 19A, an example autonomous plant care system 1900 is illustrated that may be configured for use with an external water source, which is not shown in the figure. In some examples, the system 1900 may be configured to receive water from an external water source and to transfer the received water for use in provisioning the system.

In some examples, the system 1900 may include a power input 1001, an electronics module 1003, a water inlet 1002, a fluid conduit 1122, and a water distribution element 1014. The electronics module 1003 may be configured to control operation of one or more system components.

In some examples, a fluid control device 1605 may be operant to assist in transferring water from the fluid conduit 1122 to the water distribution element 1014. In some examples, the fluid control device 1605 may be implemented as a pump configured to draw water from the fluid conduit 1122 via the water inlet 1002 and deliver the water to the water distribution element 1014 at a desired pressure.

In other examples, the fluid control device 1605 may be implemented as a valve or other flow-control element rather than a pump. In such examples, water supplied to the system via the fluid conduit 1122 may already be at sufficient pressure, and the fluid control device 1605 may be configured to selectively permit, restrict, or arrest fluid flow under electronic control rather than actively pressurizing the water. As described with reference to FIG. 16A, the implementation of the fluid control device 1605 may vary depending on system configuration and water source characteristics.

In some examples, the system 1900 may further include one or more soil sensing apparatuses 1013 configured to sense characteristics of a growth medium associated with a plant. Data from the sensor 1013 may be used by the electronics module 1003 to control operation of the fluid control device 1605 and the water distribution element 1014. In some examples, the system 1900 may include one or more sensors for measurements of non-substrate conditions (such as sunlight, wind speed/direction, or other possibilities as described elsewhere in this specification).

Referring now to FIG. 19B, an exemplary plant care unit 1910 is illustrated that includes modular hookups 1004 and may be configured for use with an external water source, which is not shown. In some examples, the exemplary plant care unit 1910 may receive water, nutrient solutions, or other fluids from the external source for use in provisioning plants via the modular hookups 1004.

In some examples, the exemplary plant care unit 1910 may include a fluid management assembly 1801 coupled to the modular hookups 1004. As described with reference to FIG. 18A, the fluid management assembly 1801 may include a pump, a manifold, or a combination of pumping, routing, and flow-control components configured to distribute fluid to or from one or more modular hookups. The fluid management assembly 1801 may be implemented in a simplified form or, in other examples, as a more complex assembly capable of supporting multiple modular connections and configurable fluid routing.

In some examples, the fluid management assembly 1801 may be implemented as a pump configured to actively pressurize fluid supplied to the unit 1910. In other examples, where fluid is supplied to the unit 1910 at sufficient pressure, the fluid management assembly 1801 may include one or more valves or other electronically controlled flow-control devices rather than an active pump. In such examples, the fluid management assembly 1801 may selectively permit, restrict, or direct flow of water, nutrient solutions, or other fluid mixtures supplied to the modular hookups 1004.

Referring now to FIG. 19C, an exemplary configuration of an autonomous plant support system 1920 is illustrated in which the system receives water from an external water source 1102. In the illustrated example, the external water source 1102 is depicted as a water reservoir, although other types of external water sources may be used.

In some examples, a main system body 1900 may be fluidly coupled to the external water source 1102 via a fluid conduit 1122. The fluid conduit 1122 may be configured to draw or siphon water from the external water source 1102 and deliver the water to the main system body 1900 for use by the system.

In some examples, the fluid conduit 1122 may include a filter 1606 positioned at or near an inlet of the fluid conduit. The filter 1606 may be configured to remove particulates or contaminants from the water drawn from the external water source 1102 prior to delivery to the main system body 1900. The inclusion of the filter 1606 may help protect downstream system components and improve reliability of system operation.

In some examples, multiple main system bodies 1900 (whether operant in a shared growing vessel or growing bed, or in different ones) may share a water source 1102, each with their own fluid conduit 1122 drawing water.

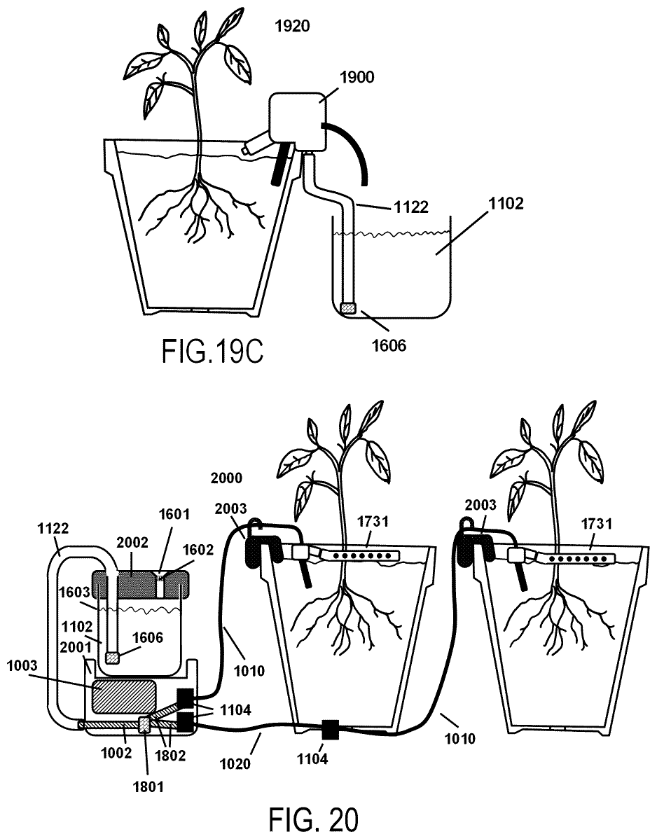

Referring now to FIG. 20, an alternative example of an autonomous plant support system 2000 is illustrated. In the illustrated example, the autonomous plant care system 2000 may be configured to provision two potted plants positioned in separate plant pots. The autonomous plant care system 2000 includes a main system body that may be molded, structured, or otherwise assembled to support integrated fluid management and modular connectivity.

In some examples, the main system body of the autonomous plant care system 2000 may include a recessed portion 2001, which may be defined at least in part by a retaining lip. The recessed portion 2001 may be configured to stably receive and support an external water source 1102. (This may be seen as an optional element, as the main system body may support the external water source 1102 without the retaining lip; though a recessed portion 2001 increases stability relative to a configuration without the retaining lip.) In the illustrated example, the external water source 1102 may be implemented as a reservoir mounted on top of the main system body. The external water source 1102 may be formed from a variety of materials, including glass or plastic. In some examples, a transparent or translucent material may permit visual observation of a water level 1603, thereby enabling a user to determine when refilling may be required. In some examples, regardless of whether the system has the optional recessed portion 2001 or not, other objects may be placed atop the main system body. Such objects may not be related to system functionality, or they may be part of the system, such as for instance a pot with a plant that may be supported by the system as a non-limiting example; in this example, the water source 1102 may be placed in an alternate location. This may be desired for aesthetic reasons, for having the water source 1102 positioned in a more-easily-accessible location for refilling, or other reasons.

In some examples, the main system body of the autonomous plant care system 2000 may include one or more modular hookups forming completed modular connections 1104. Water may be drawn from the external water source 1102 through a water input 1002 and delivered by a pump and manifold assembly 1801. Internal fluid conduits 1802 may route water from the pump and manifold assembly 1801 to the modular hookups. In the illustrated example, two active chain units 1010 are coupled in parallel to the modular hookups of the main system body. One of the active chain units 1010 may further include a pass-through extension unit 1020 to accommodate placement of a plant pot located farther from the main system body.

In some examples, the external water source 1102 may include a fill port 1601 configured to allow replenishment of water. The fill port 1601 may include a screen or filter to inhibit debris from entering the external water source 1102. The external water source 1102 may further include a cap 2002 that forms part of the autonomous plant care system 2000. In some examples, the cap 2002 may be a passive component including openings to permit filling and routing of a fluid conduit 1122. In other examples, the cap 2002 may include active components, including but not limited to electronic components, sensors, or control circuitry. For example, the cap 2002 may house an electronics module 1003, a water-level sensing apparatus configured to detect the water level 1603, a visual indicator such as an LED or display may be non-limiting examples to notify the user of a need to refill the water source 1102, or other system components. In some examples, a pump may be housed within or integrated with the cap 2002. In other examples, the cap 2002 may serve to reduce contamination, inhibit pest access, and prevent debris from entering the external water source 1102.

In the illustrated example, the fluid conduit 1122 may be shown as a dedicated fluid line. In other examples, the fluid conduit 1122 may be implemented as a more generalized transmission conduit similar to those used in the active chain units 1010, capable of conveying additional resources such as power or data.

FIG. 20 further illustrates an optional cable-routing and mounting fixture 2003. In some examples, the cable-routing and mounting fixture 2003 may be configured to support and route one or more transmission conduits associated with the active chain units 1010. The cable-routing and mounting fixture 2003 may help retain a transmission conduit in a user-specified position, provide strain relief, and improve aesthetic presentation by routing the transmission conduit along desired paths and reducing visual clutter.

In some examples, the cable-routing and mounting fixture 2003 may include geometric features configured to maintain a minimum bend radius of the transmission conduit if the transmission conduit is routed over an edge or lip of a plant pot. Such features may reduce the likelihood of kinking, flow restriction, or damage within the transmission conduit. The cable-routing and mounting fixture 2003 may include one or more clips, hooks, channels, or retention features and may be configured to route a single transmission conduit or multiple transmission conduits. The cable-routing and mounting fixture 2003 may be provided in various colors, materials, sizes, or patterns and may be mountable at different locations on a plant pot or other supporting structure for purposes of aesthetics or function. The illustrated configuration is provided as one non-limiting example.

It may be noted that this example illustrated in FIG. 20 may be one where the individual elements of the system may not individually possess the full required set of hardware and capabilities to function independently as an autonomous plant support system (in the way of the main system body illustrated in FIG. 16A). Rather, this example may be able to function as an expandable and scalable autonomous plant care system with connected modular components, which together may achieve the full required set of hardware and capabilities of an autonomous plant support system.

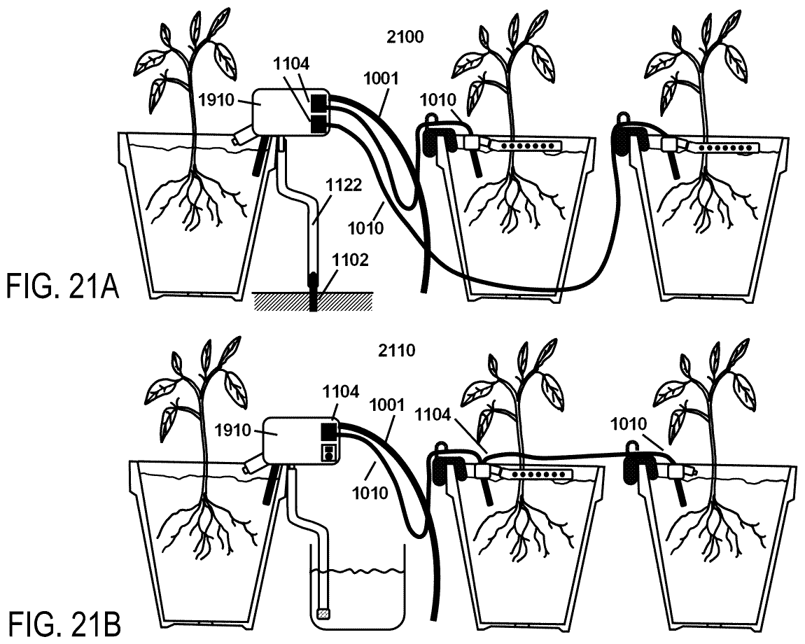

Referring now to FIG. 21A, an exemplary plant care system configuration 2100 is illustrated that includes modular hookups. The example illustrated in FIG. 21A may be considered in conjunction with the example illustrated in FIG. 21B, as both examples depict alternative configurations for provisioning the same set of two potted plants. The configurations share a number of functional characteristics, while differing in certain structural and connection arrangements that demonstrate different permutations of the system.

In the example of FIG. 21A, an external water source 1102 is depicted as a pressurized water supply provided through a wall surface or floor surface and coupled to the system via a fitting. In some examples, the fitting may be implemented as a barbed fitting configured to receive a fluid conduit 1122 formed from flexible tubing. Such a configuration may allow the fluid conduit 1122 to be easily attached and retained under pressure and may further allow the fluid conduit 1122 to be readily removed when the external water source 1102 is valved closed. Other fitting types or connection mechanisms may alternatively be used, and the illustrated configuration is provided as one non-limiting example.

In some examples, the plant care system configuration 2100 may include two completed modular connections 1104 that couple two active chain units 1010 to a main system body in parallel to each other. In this parallel configuration, each active chain unit 1010 may be connected directly to the main system body and may independently provide soil sensing and water distribution to a corresponding plant pot.

By contrast, in the example illustrated in FIG. 21B, the external water source 1102 may be implemented as a standing water reservoir, and the active chain units 1010 are arranged in a serial configuration. In such a serial arrangement, a first active chain unit 1010 may be connected to the main system body via a completed modular connection 1104, and a second active chain unit 1010 may be connected to the first active chain unit 1010 via an additional completed modular connection 1104. Despite the difference between parallel and serial configurations, both system arrangements may provide comparable soil sensing capability and water distribution capability for each plant.

In some examples, a user may select between parallel and serial configurations based on plant layout, desired transmission conduit routing, aesthetic considerations, installation constraints, or functional preferences. One benefit of the modular architecture described herein may be that the system may function similarly from a user perspective while allowing flexible customization of physical configuration with minimal effort. In such examples, the system may be configured as a plug-and-play arrangement that enables such customization without requiring specialized tools or expertise.

In some examples, an additional distinction between the illustrated configurations may include selective use of drip lines. For example, in a serial configuration, one active chain unit 1010 may be operated without an attached drip line, while another active chain unit 1010 may include a drip line for localized water delivery. In such examples, water from a water distribution element may be delivered directly to the growth medium without a drip line where such delivery may be sufficient for a particular plant. These variations further illustrate non-limiting permutations of the system based on user preference and plant requirements.

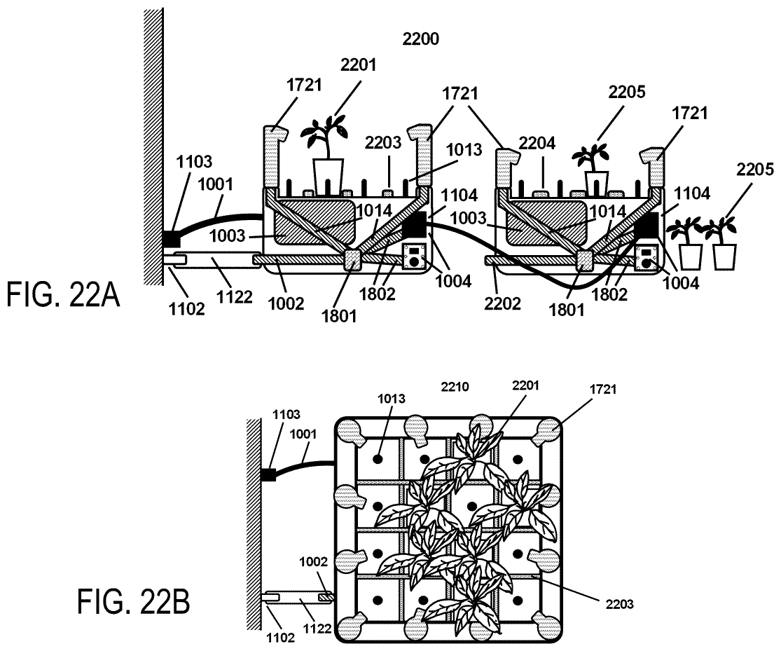

Referring now to FIG. 22A and FIG. 22B, two views of exemplary configurations of an autonomous plant support system 2200 and 2210 are illustrated. FIG. 22A and FIG. 22B are intended to be viewed in conjunction and depict different perspectives of exemplary system arrangements. In the illustrated example of FIG. 22A, the autonomous plant support system 2200 includes main system body units coupled together via a pass-through chain using completed modular connections 1104.

In some examples, a first system unit of the autonomous plant support system 2200 may receive water through a water input 1002 that may be fluidly coupled to a fluid conduit 1122 connected to an external wall-mounted water source 1102. Water received from the external water source 1102 may be routed through a pump and manifold assembly 1801, which may be configured to deliver water at pressure. Internal fluid conduits 1802 may route the pressurized water from the pump and manifold assembly 1801 to one or more modular hookups and to multiple water distribution elements 1014.

In some examples, the water distribution elements 1014 may be coupled to one or more spray nozzles 1721 arranged around a perimeter of the system unit, as shown in greater detail in FIG. 22B. The spray nozzles 1721 may be configured to distribute water across multiple plant locations in a distributed or misting pattern.

In the illustrated example, a second system unit of the autonomous plant support system 2200 is shown without a direct connection to a separate water input. Instead, the second system unit may receive water through the modular pass-through chain via completed modular connections 1104. In such examples, a modular hookup may function as a fluid input rather than a fluid output. Water received through the modular hookup may be routed to a pump and manifold assembly 1801 of the second system unit, which may distribute the water internally in a manner similar to the first system unit. In some examples, electronics and control hardware may be configured to detect whether a modular hookup is operating as an input or an output and to control fluid routing accordingly. It should be noted that the modular pass-through chain of this example includes two modular connectors, rather than a modular connector and modular hookup pair illustrated in previous examples. This allows the modular pass-through chain to directly connect two main system bodies that only have modular hookups. Different configurations of modular pass-through chains are possible in different examples, with this as a non-limiting example.

In some examples, the autonomous plant support system 2200 may be configured to support multiple plantings, including one or more larger plantings 2201 and one or more smaller plantings 2205. The illustrated configuration may be particularly suitable for use in environments such as plant nurseries, where multiple seedlings or young plants are tended simultaneously.

In some examples, the plantings 2201 and 2205 may be positioned in pots or pot inserts that are placeable over substrate sensor probes 1013. In one non-limiting example, a substrate sensor probe 1013 may extend through an opening in a bottom portion of a seedling pot such that a sensing element may be positioned within the soil proximate to developing roots. In some examples, the pots or pot inserts may have active or passive components that function as part of the autonomous plant support system, such as sensors, channels for routing fluids for distribution, or other possible examples. In some examples, the pots or pot inserts may have identifying information for tracking purposes, such as QR codes or RFID tags as non-limiting examples, to be assessed by the system through visual means, RFID tag scanning, or other possibilities. This data may be tracked and linked to sensor data, images gathered by the system or input by users, or other possible data to track the life cycle of the plant, with the system having an ability to link the data to the specific plant as it changes vessels over its life cycle. This may provide historical data which may be used by the system or AI for system control, care or location recommendations to the user, or other conceivable uses for such stored plant-identified information.

In some examples, the autonomous plant support system 2200 may include multiple plant-receiving locations separated by configurable separation bars 2203. The separation bars 2203 may be adjustable or interchangeable to accommodate different pot or pot insert sizes. In the illustrated example, a second system unit includes separation bars spanning a larger distance, with a pot guide structure 2204 configured to receive smaller pots and help maintain the pots in fixed positions. Such features may help prevent plant pots from tipping, shifting, or losing proper alignment with substrate sensors when the system is moved or inadvertently disturbed.

In some examples, numerous alternative configurations are possible beyond the illustrated example. Such variations may include different internal fluid routing architectures, different numbers or arrangements of modular hookups, and different implementations of pumps, valves, manifolds, or other fluid-control devices. Water distribution may be provided via spray nozzles, drip lines, externally mounted sprinklers, or other irrigation apparatuses. In some examples, the main system body may function primarily as a sensing and control platform that communicates with an external irrigation system to incorporate water distribution into the system, rather than directly distributing water via the main system body.

In some examples, watering decisions may be made based on aggregated soil condition data collected from multiple substrate sensor probes 1013, and water distribution may be controlled to reduce over-watering or under-watering across the plantings. Fluids delivered through the system may include water, nutrient solutions, or other fluid mixtures as described in other examples herein. The configuration illustrated in FIGS. 22A and 22B is provided as one non-limiting example of the modular and configurable nature of the system.

### Plant Support System Overview

In some examples, a plant support system may include a support structure positioned proximate to a plant growth substrate. The support structure may be used with potted plants, planters, or planting beds, and may be configured to physically integrate with, be positioned within, or be positioned adjacent to the plant growth environment. In other non-limiting examples, a plant support system may not include a support structure, such as for plants planted directly into the ground, and the plant support system may be placed proximate to a plant growth substrate without further support.

In some examples, the plant support system may further include a fluid access mechanism configured to selectively deliver fluid to the plant growth substrate. The delivered fluid may include water, nutrient solutions, or combinations thereof. Fluid delivery may be performed using one or more pumps, valves, gravity-fed conduits, pressurized fluid interfaces, or combinations of these elements.

In some examples, the plant support system may include at least one substrate sensing mechanism configured to evaluate one or more conditions of the plant growth substrate. Sensed conditions may include moisture content, water availability, matric potential, nutrient concentration, electrical conductivity, pH, temperature, or combinations thereof. In some examples, a plurality of sensing elements may be positioned at different depths or lateral locations within the substrate to provide spatially distributed sensing of substrate conditions.

In some examples, a programmable control subsystem may be operatively coupled to the substrate sensing mechanism and the fluid access mechanism. The programmable control subsystem may be configured to interpret sensed substrate conditions and to automatically regulate delivery of fluid based at least in part on the sensed conditions. In some examples, the programmable control subsystem may duty-cycle operation of one or more sensing elements to reduce sensor degradation or energy consumption. In some examples, sensor-layer processing and control-layer processing may be implemented as separate logical or functional modules, and historical substrate data may be used to adapt fluid delivery parameters over time.

In some examples, a power subsystem supplies electrical energy to the programmable control subsystem and associated components. In such examples, the plant support system may operate autonomously without continuous user intervention. In some examples, the same plant support system architecture may be adapted for residential, indoor, outdoor, commercial, or greenhouse environments through parameter adjustment rather than structural redesign.

In some examples, the plant support system may be configured as a modular system. A main system body may include the programmable control subsystem and a fluid management subsystem, and one or more plant-interfacing modules may be operatively coupled to the main system body through one or more modular connections. In some examples, each plant-interfacing module may include a substrate sensing mechanism and a localized fluid delivery element. The modular connections may be configured to convey electrical power, data, fluid, or combinations thereof, and may operate as bidirectional interfaces depending on connection state or control logic.

In some examples, multiple plant-interfacing modules may be arranged in serial, parallel, or hybrid configurations. System scale may be adjusted by adding or removing plant-interfacing modules without modification of underlying control logic. In some examples, one or more plant-interfacing modules may perform local control decisions independently of the main system body.

In some examples, the plant support system may include a plant support unit having an onboard fluid reservoir and a programmable control subsystem to detect the fill level of the reservoir. The refill interface may be configured to notify the user of a need to refill and supply a port for the user to refill water with. In other examples, the plant support system may receive water from an external water source that does not need to be refilled by a user.

In some examples, the plant support system may be networked to nearby devices or to the internet, to provide data to a database or receive commands or inputs from a user. In this example, a user may access a user interface where this data is stored, where the user may input commands to the plant support system, or perform other exemplary operations. In other examples, the plant support system may not be networked to nearby devices or to the internet, to function autonomously based on sensor data.

In some examples, the plant support system may include a plant support unit having an onboard fluid reservoir and a programmable control subsystem, together with an alignment-aware refill interface. The refill interface may be configured to enable automated replenishment of the fluid reservoir by an autonomous provisioning device. In some examples, the programmable control subsystem may generate a refill request based on sensed operating conditions, and the refill interface may be tolerant to positional or angular misalignment during engagement.

In some examples, the refill interface may include one or more mechanical guide features, visual markers, sensor-detectable features, fluid coupling geometries, or combinations thereof. In some examples, the refill interface may support transfer of water, nutrients, electrical power, data, or combinations thereof.

In some examples, one or more sensing or control functions of the plant support system may employ machine learning. In such examples, sensor-layer processing modules, control-layer processing modules, or both may employ learned models to improve interpretation of sensed conditions, prediction of plant needs, or optimization of fluid delivery behavior over time.

### Conclusion

A number of examples of the present disclosure have been described. While this specification contains many specific implementation details, they should not be construed as limitations on the scope of any inventions or of what may be Claimed, but rather as descriptions of features specific to particular examples of the present disclosure.

Certain features that are described in this specification in the context of separate examples may also be implemented in combination in a single embodiment. Conversely, various features that are described in the context of a single embodiment may also be implemented in combination in multiple examples separately or in any suitable sub-combination. Moreover, although features may be described above as acting in certain combinations and even initially Claimed as such, one or more features from a Claimed combination can in some cases be excised from the combination, and the Claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous.

Moreover, the separation of various system components in the examples described above should not be understood as requiring such separation in all examples, and it should be understood that the described components and systems can generally be integrated together in a single product or packaged into multiple products.

Thus, particular examples of the subject matter have been described. Other examples are within the scope of the following Claims. In some cases, the actions recited in the Claims can be performed in a different order and still achieve desirable results. In addition, the processes depicted in the accompanying figures do not necessarily require the particular order shown, or sequential order, to achieve desirable results. In certain implementations, multitasking and parallel processing may be advantageous. Nevertheless, it will be understood that various modifications may be made without departing from the spirit and scope of the Claimed invention. While the disclosure has been described in conjunction with specific examples, it is evident that many alternatives, modifications, and variations will be apparent to those skilled in the art in light of the foregoing description. Accordingly, this description is intended to embrace all such alternatives, modifications, and variations as fall within its spirit and scope. Certain features that are described in this specification in the context of separate embodiments can also be implemented in combination in a single embodiment. Conversely, various features that are described in the context of a single embodiment can also be implemented in combination in multiple embodiments separately or in any suitable sub-combination. Moreover, although features may be described above as acting in certain combinations and even initially Claimed as such, one or more features from a Claimed combination can in some cases be excised from the combination, and the Claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous.

Moreover, the separation of various system components in the embodiments described above should not be understood as requiring such separation in all embodiments. Examples of mobile provisioning systems may include all system components or a subset of components and may act in multiples to perform various functions. Thus, while particular embodiments of the subject matter have been described, other embodiments are within the scope of the following Claims.

What is claimed is:

1. A plant support system comprising:
a support structure configured to be positioned proximate to a plant growth substrate;
a fluid access mechanism configured to selectively deliver fluid to the plant growth substrate;
at least one substrate sensing mechanism configured to evaluate a condition of the plant growth substrate;
a programmable control subsystem operatively coupled to the substrate sensing mechanism and the fluid access mechanism;
a power subsystem configured to supply electrical energy to the programmable control subsystem; and
wherein the programmable control subsystem is configured to automatically control delivery of the fluid based at least in part on sensed substrate conditions, and wherein the plant support system operates autonomously without continuous user intervention.

2. The plant support system of claim 1, wherein the support structure is configured for placement within, on, or relative to a plant pot or planter.

3. The plant support system of claim 1, wherein the support structure is configured for placement within, adjacent to, or above a planting bed.

4. The plant support system of claim 1, wherein the substrate sensing mechanism is configured to sense at least one of moisture content, water availability, matric potential, nutrient concentration, electrical conductivity, pH, temperature, or combinations thereof.

5. The plant support system of claim 1, wherein the substrate sensing mechanism comprises a plurality of sensing elements positioned at different depths or lateral locations within the substrate.

6. The plant support system of claim 1, wherein the programmable control subsystem is configured to duty-cycle operation of the substrate sensing mechanism to reduce sensor degradation or energy consumption.

7. The plant support system of claim 1, wherein the fluid access mechanism comprises at least one of a pump, valve, manifold assembly, gravity-fed conduit, or pressurized fluid interface.

8. The plant support system of claim 1, wherein the fluid access mechanism is configured to deliver water, nutrient solutions, or combinations thereof.

9. The plant support system of claim 1, wherein the programmable control subsystem employs a sensor-layer processing module configured to interpret raw sensor data and a control-layer processing module configured to generate actuation commands.

10. The plant support system of claim 1, wherein the programmable control subsystem adapts fluid delivery parameters based on historical substrate data.

11. The plant support system of claim 1, wherein the system operates across residential, commercial, or greenhouse environments by parameter adjustment rather than structural redesign.

12. A modular plant care system comprising:
a main system body including a programmable control subsystem and a fluid management subsystem;
at least one plant-interfacing module operatively coupled to the main system body via a modular connection, the plant-interfacing module including one or more of:
a substrate sensing mechanism; and
a localized fluid delivery element; and
wherein the modular connection is configured to convey at least two of electrical power, data, or fluid, and wherein operational roles of the modular connection are determined dynamically based on connection state or control logic.

13. The modular plant care system of claim 12, wherein the modular connection functions as a bidirectional interface for at least one of fluid or data.

14. The modular plant care system of claim 12, wherein multiple plant-interfacing modules are arranged in serial, parallel, or hybrid configurations.

15. The modular plant care system of claim 12, wherein the main system body includes a pump-manifold assembly configured to selectively route fluid to individual modular connections.

16. The modular plant care system of claim 12, wherein at least one plant-interfacing module performs local control decisions independent of the main system body.

17. The modular plant care system of claim 12, wherein system scale is configurable by addition or removal of plant-interfacing modules without modification of control logic.

18. A plant support system comprising:
a plant support unit including a fluid reservoir and a programmable control subsystem; and
an alignment-aware refill interface configured to enable automated replenishment of the fluid reservoir by an autonomous provisioning device,
wherein the programmable control subsystem is configured to generate a refill request based on sensed operating conditions, and wherein the refill interface is tolerant to positional or angular misalignment during engagement.

19. The plant support system of claim 18, wherein the refill interface comprises at least one of a mechanical guide feature, visual marker, sensor-detectable feature, or fluid coupling geometry.

20. The plant support system of claim 18, wherein the refill interface supports transfer of at least one of water, nutrients, electrical power, or data.
